(19) United States
(12) Patent Application Publication
(10) Pub. No.: US 2024/0361724 A1
(43) Pub. Date: Oct. 31, 2024

(54) PROCESS CARTRIDGE AND ELECTROPHOTOGRAPHIC APPARATUS

(71) Applicant: CANON KABUSHIKI KAISHA, Tokyo (JP)

(72) Inventors: CHIHARU AKIYAMA, Shizuoka (JP); KANAME WATARIGUCHI, Tokyo (JP); TSUTOMU NISHIDA, Shizuoka (JP)

(21) Appl. No.: 18/646,436

(22) Filed: Apr. 25, 2024

(30) Foreign Application Priority Data
Apr. 28, 2023 (JP) 2023-075148
Feb. 26, 2024 (JP) 2024-026872

(51) Int. Cl. G03G 21/18; G03G 5/147

(52) U.S. Cl. CPC G03G 21/1814; G03G 5/14752; G03G 21/1857; G03G 2215/00957; G03G 2215/00962

(57) ABSTRACT

Provided is a process cartridge being detachably attachable onto a main body of an electrophotographic apparatus. The process cartridge includes an electrophotographic photosensitive member, a developing roller, and a toner-supplying roller. The developing roller and the toner-supplying roller are rotated so as to satisfy a particular velocity ratio so that the surface of the developing roller and the surface of the toner-supplying roller are opposite to each other at a contact position therebetween. The surface of the developing roller is a surface of an elastic layer, and the toner-supplying roller includes a shaft body and a resin layer formed on an outer peripheral surface of the shaft body. The electrophotographic photosensitive member includes a surface layer containing a polyarylate resin including a structural unit represented by the following formula (A1) and a structural unit represented by the following formula (A2).

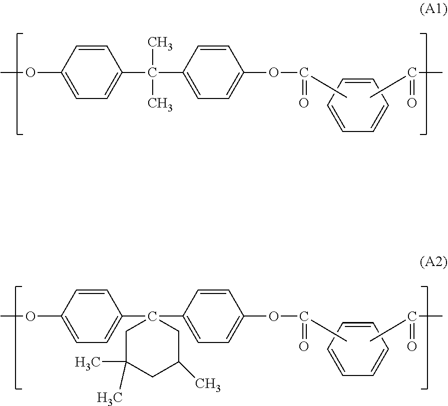

### BACKGROUND

### Field of the Disclosure

The present disclosure relates to a process cartridge and an electrophotographic apparatus each including an electrophotographic photosensitive member.

### Description of the Related Art

In recent years, the extension of the service life of an electrophotographic apparatus has been strengthened. However, in an electrophotographic process, the extension of the service life is liable to cause various adverse effects. Thus, various efforts have been made to counter various adverse effects associated with the extension of the service life.

One of the above-mentioned adverse effects is an adverse effect caused by the following: the surface states of a toner-supplying roller, a developing roller, and an electrophotographic photosensitive member (hereinafter sometimes simply referred to as “photosensitive member”) to be mounted on the electrophotographic apparatus are changed owing to repeated use of the electrophotographic apparatus. When the surface states of the toner-supplying roller, the developing roller, and the photosensitive member are changed, the abutment state between the toner-supplying roller and the developing roller or between the developing roller and the photosensitive member becomes unstable. Then, when the abutment state becomes unstable, an image defect such as the occurrence of streak-like unevenness is liable to occur. An electrophotographic image in which streak-like unevenness occurs is hereinafter sometimes referred to as “banding image.”

To solve those adverse effects, the configuration of the developing roller and the toner-supplying roller that supplies toner to the developing roller has been devised.

In Japanese Patent Application Laid-Open No. H11-249410, there is a description of a developing device in which a developer-supplying roller has a hollow in an entirety or a part of a central axis line portion. When the developer-supplying roller has a hollow, the developer-supplying roller is easily deformed in response to a stress applied to a peripheral surface thereof. Thus, occurrence of the banding image caused by an increase in drive torque of a developing roller due to the fact that the abutment pressure between the developing roller and the developer-supplying roller is not extremely high can be suppressed.

In Japanese Patent Application Laid-Open No. 2020-79902, there is a description of an image forming apparatus that satisfies the following conditions. First, the water washing migration amount of inorganic silicon fine particles on the surfaces of toner particles is 0.20 mass % or less. In addition, the range of a peripheral velocity ratio, which is the ratio of the peripheral velocity of a developer carrying member to the peripheral velocity of an image bearing member, is from 120% to 300%. Further, the dark portion potential Vd of the image bearing member and a bias Vb applied to a regulating member that regulates a developer satisfy the relationship of Vd<Vb. In Japanese Patent Application Laid-Open No. 2020-79902, the above-mentioned configuration controls the liberation of an external additive to suppress image smearing. Thus, an increase in tackiness of the surface of the photosensitive member by the adhesion of a discharge product and moisture in the atmosphere caused by the image smearing is suppressed, and the surface state of the photosensitive member can be kept stable.

In order for the developing roller and the toner-supplying roller that supplies toner to the developing roller to stably form an image of high quality even at the time of long-term use, a toner supply amount from the toner-supplying roller to the developing roller needs to be stable. In order to stabilize the toner supply amount from the toner-supplying roller to the developing roller, it is effective to adopt a configuration in which the rotation directions of the developing roller and the toner-supplying roller are opposite to each other in a rubbing portion therebetween (hereinafter referred to as “counter configuration”).

According to the investigations made by the inventors of the present disclosure, in the technologies described in Japanese Patent Application Laid-Open No. H11-249410 and Japanese Patent Application Laid-Open No. 2020-79902, when the counter configuration is adopted in order to stabilize the toner supply amount from the toner-supplying roller to the developing roller, the dynamic friction coefficient in an abutment portion between the developing roller and the photosensitive member may be increased. Then, there is a problem in that the increase in dynamic friction coefficient causes an image defect such as the occurrence of a banding image.

### SUMMARY

Thus, an object of the present disclosure is to provide a process cartridge capable of forming an electrophotographic image of high quality by stabilizing a toner supply amount from a toner-supplying roller to a developing roller and suppressing the occurrence of a banding image.

The above-mentioned object is achieved by the present disclosure to be described below. That is, a process cartridge according to the present disclosure is a process cartridge including: a process cartridge being detachably attachable onto a main body of an electrophotographic apparatus, the process cartridge including: an electrophotographic photosensitive member; a developing roller configured to develop an electrostatic latent image formed on a surface of the electrophotographic photosensitive member; and a toner-supplying roller arranged in contact with the developing roller and configured to supply toner to the developing roller, wherein the developing roller and the toner-supplying roller are configured so that a movement direction of a surface of the developing roller and a movement direction of a surface of the toner-supplying roller at the time of operation are opposite to each other at a contact position of the developing roller and the toner-supplying roller, and the developing roller and the toner-supplying roller are rotated while R represented by the following formula (E1) satisfies 1.2≤R≤1.5.

$$R = {V}_{RS} / {V}_{D} \qquad ( E1 )$$

in the formula (E1), VRS represents an absolute value of a peripheral velocity [m/s] of the toner-supplying roller, and V_{D} represents an absolute value of a peripheral velocity [m/s] of the developing roller, wherein the surface of the developing roller is a surface of an elastic layer, wherein the toner-supplying roller includes a shaft body and a resin layer formed on an outer peripheral surface of the shaft body, and wherein the electrophotographic photosensitive member includes a surface layer containing a polyarylate resin including a structural unit represented by the following formula (A1) and a structural unit represented by the following formula (A2).

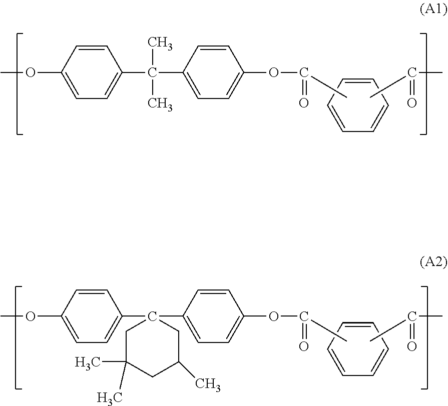

Further features of the present disclosure will become apparent from the following description of exemplary embodiments with reference to the attached drawings.

### BRIEF DESCRIPTION OF THE DRAWINGS

FIG. 1 is a schematic sectional view of a process cartridge according to one embodiment of the present disclosure.

FIG. 2 is a schematic view for illustrating the drive mechanism of a toner-supplying roller and a developing roller according to one embodiment of the present disclosure.

FIG. 3 is a schematic view for illustrating the drive mechanism of a toner-supplying roller and a developing roller according to one embodiment of the present disclosure.

### DESCRIPTION OF THE EMBODIMENTS

The present disclosure is described in detail below by way of exemplary embodiments.

The present disclosure relates to a process cartridge being detachably attachable onto a main body of an electrophotographic apparatus, the process cartridge including: an electrophotographic photosensitive member; a developing roller configured to develop an electrostatic latent image formed on a surface of the electrophotographic photosensitive member; and a toner-supplying roller arranged in contact with the developing roller and configured to supply toner to the developing roller, wherein the developing roller and the toner-supplying roller are configured so that a movement direction of a surface of the developing roller and a movement direction of a surface of the toner-supplying roller are opposite to each other at a contact position of the developing roller and the toner-supplying roller, and the developing roller and the toner-supplying roller are rotated while R represented by the following formula (E1) satisfies 1.2≤R≤1.5:

$$R = {V}_{RS} / {V}_{D} \qquad ( E1 )$$

in the formula (E1), VRS represents an absolute value of a peripheral velocity [m/s] of the toner-supplying roller, and V_{D} represents an absolute value of a peripheral velocity [m/s] of the developing roller, wherein the surface of the developing roller is a surface of an elastic layer, wherein the toner-supplying roller includes a shaft body and a resin layer on the periphery of the shaft body, and wherein the electrophotographic photosensitive member includes a surface layer containing a polyarylate resin including a structural unit represented by the following formula (A1) and a structural unit represented by the following formula (A2).

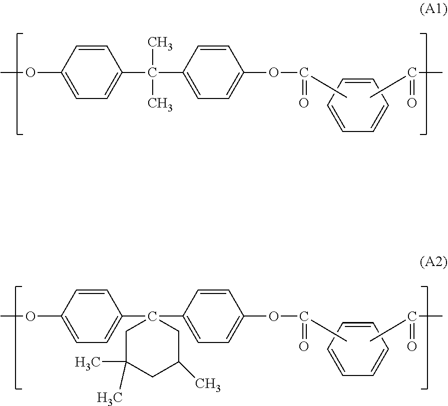

According to the investigations made by the inventors of the present disclosure, in the related art, the measures against an increase in dynamic friction coefficient between the developing roller and the photosensitive member in association with a change in surface of the developing roller have been insufficient.

In view of the foregoing, the inventors of the present disclosure have investigated the combination of the configuration of the developing roller and the toner-supplying roller, and a photosensitive member surface material, and have optimized the combination. As a result, the inventors have found that the above-mentioned problem can be solved by adopting the following configuration. First, the developing roller and the toner-supplying roller are configured so that the movement direction of the surface of the developing roller and the movement direction of the surface of the toner-supplying roller are opposite to each other at the contact position of the developing roller and the toner-supplying roller. In addition, the developing roller and the toner-supplying roller are configured to be rotated while R represented by the following formula (E1) satisfies 1.2≤R≤1.5:

$$R = {V}_{RS} / {V}_{D} \qquad Formula ( E1 )$$

in the formula (E1), VRS represents the absolute value of the peripheral velocity [m/s] of the toner-suppling roller, and V_{D} represents the absolute value of the peripheral velocity [m/s] of the developing roller.

In addition, the surface of the developing roller is the surface of the elastic layer, and the toner-supplying roller includes the shaft body and the resin layer formed on the outer peripheral surface of the shaft body. Further, the photosensitive member includes the surface layer containing the polyarylate resin including the structural unit represented by the following formula (A1) and the structural unit represented by the following formula (A2).

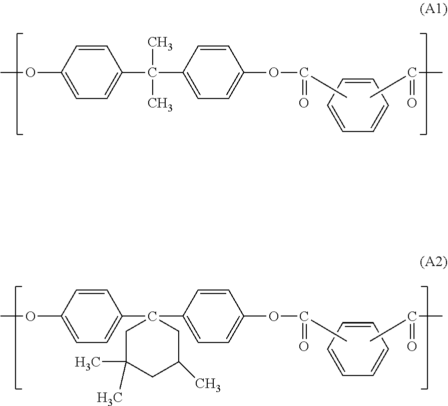

The inventors of the present disclosure have conceived the following as a mechanism capable of solving the above-mentioned problem with such configuration.

When the developing roller and the toner-supplying roller have a counter configuration, and the R is set to a value larger than 1, a toner supply amount from the toner-supplying roller to the developing roller becomes stable. However, when the developing roller and the toner-supplying roller have the counter configuration, and the R is set to a value larger than 1, the influence of friction, which is received from the toner-supplying roller, on the developing roller is significant. In the case where the friction between the developing roller and the toner-supplying roller causes a portion of the developing roller in which the surface state is unstable such as a decrease in viscoelasticity, when the portion is brought into abutment against the photosensitive member, the dynamic friction coefficient between the developing roller and the photosensitive member is increased. In addition, in the above-mentioned configuration, the influence of the friction, which is received from the toner-supplying roller, on the developing roller is significant, and the surface of the developing roller is liable to be increased in temperature by the heat of friction with the toner-supplying roller. In particular, when the surface of the developing roller is the surface of the elastic layer, the surface of the developing roller is pulled by abutment against the toner-supplying roller, with the result that the surface of the developing roller temporarily expands. When the developing roller passes by the abutment point with respect to the toner-supplying roller, the surface of the developing roller attempts to shrink by using its entropic elasticity because the developing roller itself has been increased in temperature. Simultaneously with this, a portion of the surface of the developing roller in which viscoelasticity is decreased occurs when the developing roller receives the heat of friction with the toner-supplying roller.

When the portion of the surface of the developing roller that has become unstable owing to an increase in temperature as described above is brought into abutment against the photosensitive member, the friction state of the developing roller and the photosensitive member is fluctuated, and the dynamic friction coefficient between the developing roller and the photosensitive member is increased, with the result that an image defect such as banding occurs.

In view of the foregoing, the inventors of the present disclosure have conceived incorporating the photosensitive member including the surface layer containing the polyarylate resin including the structural unit represented by the formula (A1) and the structural unit represented by the formula (A2).

Meanwhile, an ester moiety having an oxygen atom with high electronegativity is present in each of the structural unit represented by the formula (A1) and the structural unit represented by the formula (A2), and the ester moiety has polarization. Thus, the polyarylate resin is charged with δ−. In addition, meanwhile, the methyl groups of a trimethylcyclohexane structure present in the structural unit represented by the formula (A2) each have an electron-donating property, and hence the trimethylcyclohexane structure is charged with δ+. Because of this, a strong electrostatic attractive force acts between polymer molecules separately from a van der Waals force, and hence the polymer molecules are firmly bonded to each other. Accordingly, the fluctuation of the above-mentioned polyarylate resin is small with respect to an external force such as heat.

Through the incorporation of the photosensitive member including the surface layer containing the above-mentioned polyarylate resin, even when the portion of the developing roller in which the surface state is unstable is brought into abutment against the photosensitive member, the influence of the abutment is less than that of a case in which the portion is brought into abutment against a photosensitive member including a conventional surface layer. As a result, an increase in dynamic friction coefficient between the developing roller and the photosensitive member can be suppressed.

As described in the above-mentioned mechanism, the effects of the present disclosure can be achieved when the above-mentioned configuration of the developing roller and the toner-supplying roller, and the above-mentioned surface material of the photosensitive member exhibit synergistic effects on each other in the process cartridge according to the present disclosure.

The configuration of the photosensitive member used in the present disclosure is described in detail below.

### [Electrophotographic Photosensitive Member]

The photosensitive member to be used in the process cartridge according to the present disclosure includes the surface layer containing the polyarylate resin including the structural unit represented by the formula (A1) and the structural unit represented by the formula (A2).

A method of producing the photosensitive member is, for example, a method involving: preparing coating liquids for the respective layers to be described later; applying the liquids in a desired order of the layers; and drying the liquids. In this case, examples of the method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

A support and the respective layers are described below.

### <Support>

In the present disclosure, the photosensitive member includes the support. In the present disclosure, the support is preferably an electroconductive support having electroconductivity. In addition, examples of the shape of the support include a cylindrical shape, a belt shape, and a sheet shape. A support having a cylindrical shape out of those shapes is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof. An aluminum support using aluminum out of those metals is preferred.

In addition, electroconductivity may be imparted to the resin or the glass through treatment involving, for example, mixing or coating the resin or the glass with an electroconductive material.

### <Electroconductive Layer>

In the present disclosure, the photosensitive member may be arranged with an electroconductive layer on the support. The arrangement of the electroconductive layer can conceal a flaw and unevenness on the surface of the support, and can control the reflection of light on the surface of the support.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, the metal oxide is preferably used as the electroconductive particles. In particular, titanium oxide, tin oxide, or zinc oxide is more preferably used.

When the metal oxide is used as the electroconductive particles, the surface of the metal oxide may be treated with a silane coupling agent or the like, or the metal oxide may be doped with an element, such as phosphorus or aluminum, or an oxide thereof.

In addition, the electroconductive particles may each have a laminated configuration including a core particle and a covering layer covering the core particle. A material for the core particle is, for example, titanium oxide, barium sulfate, or zinc oxide, or zinc oxide. A material for the covering layer is, for example, a metal oxide such as tin oxide.

In addition, when the metal oxide is used as the electroconductive particles, the volume-average particle diameter of the particles is preferably 1 to 500 nm, more preferably 3 to 400 nm.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a concealing agent, such as a silicone oil, resin particles, or titanium oxide.

The thickness of the electroconductive layer is preferably 1 to 50 μm, particularly preferably 3 to 40 km.

The electroconductive layer may be formed by: preparing a coating liquid for an electroconductive layer containing the above-mentioned respective materials and a solvent; forming a coating film of the coating liquid; and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent. A dispersion method for the dispersion of the electroconductive particles in the coating liquid for an electroconductive layer is, for example, a method including using a paint shaker, a sand mill, a ball mill, or a liquid collision-type high-speed dispersing machine.

### <Undercoat Layer>

In the photosensitive member used in the present disclosure, an undercoat layer may be arranged on the support or the electroconductive layer. The arrangement of the undercoat layer can improve an adhesive function between layers to impart a charge injection-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having the polymerizable functional group include an isocyanate group, a blocked isocyanate group, a methylol group, an alkylated methylol group, an epoxy group, a metal alkoxide group, a hydroxy group, an amino group, a carboxyl group, a thiol group, a carboxylic acid anhydride group, and a carbon-carbon double bond group.

In addition, the undercoat layer may further contain an electron transporting substance, a metal oxide, a metal, an electroconductive polymer, and the like for the purpose of improving electric characteristics. Of those, an electron transporting substance and a metal oxide are preferably used.

Examples of the electron transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron transporting substance having a polymerizable functional group may be used as the electron transporting material and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer may further contain an additive.

The thickness of the undercoat layer is preferably 0.1 to 50 μm, more preferably 0.2 to 40 μm, particularly preferably 0.3 to 30 μm.

The undercoat layer may be formed by: preparing a coating liquid for an undercoat layer containing the above-mentioned respective materials and a solvent; forming a coating film of the coating liquid; and drying and/or curing the coating film. Examples of the solvent to be used in the coating liquid include an alcohol-based solvent, a ketone-based solvent, an ether-based solvent, an ester-based solvent, and an aromatic hydrocarbon-based solvent.

### <Photosensitive Layer>

The photosensitive layer of the photosensitive member used in the present disclosure is mainly classified into (1) a laminate type photosensitive layer and (2) a monolayer type photosensitive layer. (1) The laminate type photosensitive layer includes a charge generating layer containing a charge generating substance and a charge transporting layer containing a charge transporting substance. (2) The monolayer type photosensitive layer includes a photosensitive layer containing both of the charge generating substance and the charge transporting substance.

### (1) Laminate Type Photosensitive Layer

The laminate type photosensitive layer includes the charge generating layer and the charge transporting layer.

### (1-1) Charge Generating Layer

The charge generating layer preferably contains the charge generating substance and a resin.

Examples of the charge generating substance include an azo pigment, a perylene pigment, a polycyclic quinone pigment, an indigo pigment, and a phthalocyanine pigment. Of those, an azo pigment and a phthalocyanine pigment are preferred. Of the phthalocyanine pigments, an oxytitanium phthalocyanine pigment, a chlorogallium phthalocyanine pigment, and a hydroxygallium phthalocyanine pigment are preferred.

The content of the charge generating substance in the charge generating layer is preferably 40 to 85 mass %, more preferably 60 to 80 mass % with respect to the total mass of the charge generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge generating layer may further contain an additive, such as an antioxidant or a UV absorber. Specific examples thereof include a hindered phenol compound, a hindered amine compound, a sulfur compound, a phosphorus compound, and a benzophenone compound.

The thickness of the charge generating layer is preferably 0.1 to 1 μm, more preferably 0.15 to 0.4 μm.

The charge generating layer may be formed by: preparing a coating liquid for a charge generating layer containing the above-mentioned respective materials and a solvent; forming a coating film of the coating liquid; and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent.

### (1-2) Charge Transporting Layer

The charge transporting layer preferably contains the charge transporting substance and a resin.

Examples of the charge transporting substance include a polycyclic aromatic compound, a heterocyclic compound, a hydrazone compound, a styryl compound, an enamine compound, a benzidine compound, a triarylamine compound, and a resin having a group derived from each of these substances. Of those, a triarylamine compound and a benzidine compound are preferred.

The content of the charge transporting substance in the charge transporting layer is preferably 25 to 70 mass %, more preferably 30 to 55 mass % with respect to the total mass of the charge transporting layer.

Examples of the resin include a polyester resin, a polycarbonate resin, an acrylic resin, and a polystyrene resin. Of those, a polycarbonate resin and a polyester resin are preferred. A polyarylate resin is particularly preferred as the polyester resin.

A content ratio (mass ratio) between the charge transporting substance and the resin is preferably 4:10 to 20:10, more preferably 5:10 to 12:10.

In addition, the charge transporting layer may contain an additive, such as an antioxidant, a UV absorber, a plasticizer, a leveling agent, a slipperiness-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The thickness of the charge transporting layer is preferably 5 to 50 μm, more preferably 8 to 40 μm, particularly preferably 10 to 30 μm.

The charge transporting layer may be formed by: preparing a coating liquid for a charge transporting layer containing the above-mentioned respective materials and a solvent; forming a coating film of the coating liquid; and drying the coating film. Examples of the solvent to be used in the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

### (2) Monolayer Type Photosensitive Layer

The monolayer type photosensitive layer may be formed by: preparing a coating liquid for a photosensitive layer containing the charge generating substance, the charge transporting substance, a resin, and a solvent; forming a coating film of the coating liquid; and drying the coating film. The charge generating substance, the charge transporting substance, and the resin are the same as the examples of the materials in the above-mentioned section “(1) Laminate Type Photosensitive Layer.”

### <Protection Layer>

In the photosensitive member used in the present disclosure, a protection layer may be arranged on the photosensitive layer. The arrangement of the protection layer can improve durability.

The protection layer preferably contains electroconductive particles and/or a charge transporting substance, and a resin.

Examples of the electroconductive particles include particles of metal oxides, such as titanium oxide, zinc oxide, tin oxide, and indium oxide.

Examples of the charge transporting substance include a polycyclic aromatic compound, a heterocyclic compound, a hydrazone compound, a styryl compound, an enamine compound, a benzidine compound, a triarylamine compound, and a resin having a group derived from each of these substances. Of those, a triarylamine compound and a benzidine compound are preferred.

Examples of the resin include a polyester resin, an acrylic resin, a phenoxy resin, a polycarbonate resin, a polystyrene resin, a phenol resin, a melamine resin, and an epoxy resin. Of those, a polycarbonate resin, a polyester resin, and an acrylic resin are preferred.

In addition, the protection layer may be formed as a cured film by polymerizing a composition containing a monomer having a polymerizable functional group. As a reaction in this case, there are given, for example, a thermal polymerization reaction, a photopolymerization reaction, and a radiation polymerization reaction. Examples of the polymerizable functional group of the monomer having a polymerizable functional group include an acryloyl group and a methacryloyl group. A material having a charge transporting ability may be used as the monomer having a polymerizable functional group.

The protection layer may contain an additive, such as an antioxidant, a UV absorber, a plasticizer, a leveling agent, a slipperiness-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The protection layer has a thickness of preferably 0.5 to 10 μm, more preferably 1 to 7 μm.

The protection layer may be formed by preparing a coating liquid for a protection layer containing the above-mentioned materials and a solvent, forming a coat thereof, and drying and/or curing the coat. Examples of the solvent to be used for the coating liquid include an alcohol-based solvent, a ketone-based solvent, an ether-based solvent, a sulfoxide-based solvent, an ester-based solvent, and an aromatic hydrocarbon-based solvent.

### <Surface Layer>

In the photosensitive member to be used in the present disclosure, the surface layer contains the polyarylate resin including the structural unit represented by the following formula (A1) and the structural unit represented by the following formula (A2).

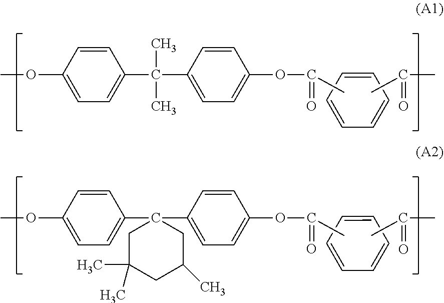

The surface layer as used herein is a portion in which the photosensitive member is brought into contact with toner and various members during an electrophotographic process. The protection layer, the charge transporting layer, and the monolayer type photosensitive layer may each be the surface layer, but the surface layer is preferably the charge transporting layer from the viewpoint of achieving both of cost and basic electrical characteristics in the electrophotographic process.

A ¹H-nuclear magnetic resonance spectrum obtained by subjecting a polymer component recovered from the surface layer of the photosensitive member to ¹H-nuclear magnetic resonance (NMR) analysis in deuterated chloroform can have peaks at the following positions. That is, the ¹H-nuclear magnetic resonance spectrum can have peaks at 8.97±0.02 ppm, 8.43±0.02 ppm, 7.67±0.02 ppm, 8.30±0.02 ppm, 1.71±0.03 ppm, 0.42±0.02 ppm, and 1.01±0.02 ppm.

The ¹H-nuclear magnetic resonance spectrum having peaks at the positions of 8.97±0.02 ppm, 8.43±0.02 ppm, and 7.67±0.02 ppm indicates that an isophthalic acid (IPA) structure included in the formula (A1) or the formula (A2) is present. In addition, the ¹H-nuclear magnetic resonance spectrum having a peak at the position of 8.30±0.02 ppm indicates that a terephthalic acid (TPA) structure included in the formula (A1) or the formula (A2) is present. In addition, the ¹H-nuclear magnetic resonance spectrum having a peak at the position of 1.71±0.03 ppm indicates that a bisphenol A structure included in the formula (A1) is present. In addition, the ¹H-nuclear magnetic resonance spectrum having peaks at the positions of 0.42±0.02 ppm and 1.01±0.02 ppm indicates that a bisphenol TMC structure included in the formula (A2) is present. Thus, the ¹H-nuclear magnetic resonance spectrum having all the peaks described above indicates that the surface layer contains a compound including the structural unit represented by the formula (A1) and the structural unit represented by the formula (A2).

Specific methods for the recovery of the polymer component from the surface layer of the photosensitive member and the NMR analysis are described below.

<Recovery of Polymer Component from Surface Layer>

The recovery of the polymer component from the surface layer of the photosensitive member is performed by the following procedure through the reprecipitation of a resin in the surface layer.

### 1. Cutting of Photosensitive Member

The photosensitive member is cut at a position distant from the end portion of the photosensitive member by 10 cm in its generating line direction with a scroll saw.

2. Washing of Inner Surface of 10 cm Photosensitive Member Having been Cut Out

The inner surface of the photosensitive member is wiped with lens-cleaning paper impregnated with chloroform.

### 3. Elution of Surface Layer

A portion corresponding to 3 cm from the end portion of the photosensitive member on the cut surface side is immersed in chloroform.

Specifically, about 60 cc of chloroform is loaded into a 100 mL beaker, and the immersion is performed at normal temperature for 5 minutes.

### 4. Concentration (Preparation of Concentrated Solution)

The resultant is concentrated to 2 mL with a rotary evaporator.

### 5. Reprecipitation

50 Milliliters of a methanol/acetone mixed liquid (volume ratio: 1:1) is prepared, and the whole amount of the concentrated solution is dropped thereinto under stirring.

### 6. Filtration

A paper filter (No. 5C-40, manufactured by Kiriyama Glass Co.) is set on a Kiriyama funnel (SU-40, manufactured by Kiriyama Glass Co.), and suction filtration is performed.

### 7. Drying

The residue on the paper filter is recovered with a spatula, and is subjected to vacuum drying (70° C., 1 hour).

### <NMR Analysis>

### Preparation of Measurement Sample

20 Milligrams of a sample is dissolved into 1 g of deuterated chloroform containing tetramethylsilane serving as a reference substance, and the whole amount thereof is transferred to a tube for ¹H-NMR analysis. For example, deuterated chloroform (manufactured by Sigma-Aldrich Japan G.K., chloroform-d, model number: 612200) may be used as the deuterated chloroform. In addition, an NMR tube (manufactured by Norell, Inc., ST500-7, model number: S3010) may be used as the tube for ¹H-NMR analysis.

### NMR Spectrum Measurement

Apparatus: AVANCE 500 manufactured by Bruker
Conditions: Proton NMR, automatic measurement with Icon-NMR
Number of scans: 32
Reference peak: The peak of a methyl group of tetramethylsilane is set as 0 ppm.

The molar ratio between the structural unit represented by the formula (A1) and the structural unit represented by the formula (A2) in the surface layer of the photosensitive member preferably falls within a range of from 1.4:0.7 to 1.0:1.1 (structural unit represented by the formula (A1):structural unit represented by the formula (A2)) from the viewpoint of mechanical strength. In addition, from the viewpoint of suppressing an increase in dynamic friction coefficient between the developing roller and the photosensitive member, the content ratio of the above-mentioned polyarylate resin in the surface layer of the photosensitive member preferably satisfies the following conditions. That is, the content ratio of the polyarylate resin including the structural unit represented by the formula (A1) and the structural unit represented by the formula (A2) with respect to the total mass of the surface layer is preferably 15 mass % or more, more preferably 20 mass % or more.

### [Developing Roller]

In the developing roller to be used in the present disclosure, the surface of the developing roller needs to be the surface of the elastic layer. The developing roller is an elastic roller having a configuration in which an electroconductive elastic rubber layer having a predetermined volume resistance, the layer serving as an elastic layer, is arranged on the periphery of an electroconductive substrate, for example, a metal core made of a metal.

The configuration of the developing roller according to one aspect of the present disclosure is described below in detail.

### <Electroconductive Substrate>

A columnar or hollow cylindrical electroconductive mandrel may be used as the electroconductive substrate. The shape of the mandrel is a columnar shape or a hollow cylindrical shape, and the mandrel may be formed of the following electroconductive material. That is, examples of the electroconductive material include: a metal or an alloy, such as aluminum, a copper alloy, or stainless steel; iron subjected to plating treatment with chromium or nickel; and a synthetic resin having electroconductivity. A known adhesive may be appropriately applied to the surface of the electroconductive substrate for the purpose of improving its adhesive property with, for example, the elastic layer arranged on the outer periphery of the electroconductive substrate.

### <Elastic Layer>

The elastic layer may include a plurality of layers having different characteristics depending on required functions. The elastic layer is typically preferably formed of a molded body of a rubber material. Examples of the rubber material include an ethylene-propylene-diene copolymerized rubber (EPDM), an acrylonitrile-butadiene rubber (NBR), a chloroprene rubber (CR), a natural rubber (NR), an isoprene rubber (IR), a styrene-butadiene rubber (SBR), a fluororubber, a silicone rubber, an epichlorohydrin rubber, a hydrogenated product of NBR, and a urethane rubber. Those rubber materials may be used alone or in combination thereof.

In addition, the surface of the elastic layer may be subjected to commonly known surface treatment, for example, UV treatment, electron beam treatment, or impregnation treatment in accordance with required characteristics.

From the viewpoint of suppressing a change in dynamic friction coefficient between the developing roller and the photosensitive member, the MD-1 hardness measured at a temperature of 23° C. for the outer surface of the developing roller is preferably 20° to 55°, more preferably 37° to 55°.

Electroconductivity may be imparted to the elastic layer by blending an electroconductivity-imparting agent, such as an electronic electroconductive substance or an ionic electroconductive substance.

Examples of the electronic electroconductive substance include: electroconductive carbons including carbon blacks, such as ketjen black EC and acetylene black, carbons for rubbers, such as super abrasion furnace (SAF), intermediate SAF (ISAF), high abrasion furnace (HAF), fast extruding furnace (FEF), general purpose furnace (GPF), semi-reinforcing furnace (SRF), fine thermal (FT), and medium thermal (MT), and carbons for colors (inks) each subjected to oxidation treatment; and metals, such as copper, silver, and germanium, and metal oxides thereof. Of those, electroconductive carbon is preferred because the electroconductivity can be easily controlled with a small amount.

Examples of the ionic electroconductive substance include: inorganic ionic electroconductive substances, such as sodium perchlorate, lithium perchlorate, calcium perchlorate, and lithium chloride; and organic ionic electroconductive substances, such as a modified aliphatic dimethylammonium ethosulfate and stearylammonium acetate.

Those electroconductivity-imparting agents are each appropriately blended in a required amount in accordance with the electroconductivity required in the elastic layer.

Various additives, such as particles, an electroconductive agent, a plasticizer, a filler, an extender, a crosslinking agent, a crosslinking accelerator, a vulcanization aid, a crosslinking aid, an acid acceptor, a curing inhibitor, an antioxidant, and an age inhibitor, may each be further incorporated into the elastic layer as required. Those optional components may each be blended in an amount in such a range that the features of the present disclosure are not impaired.

Examples of the crosslinking agent include sulfur-based crosslinking agents including sulfur, such as powdered sulfur, oil-treated powdered sulfur, precipitated sulfur, colloidal sulfur, or dispersible sulfur, and organic sulfur-containing compounds, such as tetramethylthiuram disulfide and N,N-dithiobismorpholine. The blending ratio of the sulfur is preferably 0.5 to 2.0 parts by mass per 100 parts by mass of the total amount of the rubber material in consideration of impartment of satisfactory characteristics as the rubber. In addition, when the organic sulfur-containing compound is used as the crosslinking agent, the amount of sulfur in a molecule thereof is preferably adjusted to the ratio within the above-mentioned range.

For example, zinc oxide, silica, carbon black, talc, calcium carbonate, magnesium carbonate, and aluminum hydroxide may each be used as the filler. The mechanical strength of a binder resin can be expected to be improved by blending any such filler. In addition, as described above, electronic electroconductivity may be imparted to an electrophotographic member by using electroconductive carbon black that functions as an electronic electroconductive agent as the filler. The filler is appropriately blended in a required amount in accordance with characteristics required for a molded body.

Next, the configuration of the toner-supplying roller to be used in the present disclosure is described in detail below.

### [Toner-Supplying Roller]

It is required that the toner-supplying roller to be used in the present disclosure include an electroconductive shaft body and a resin layer formed on the shaft body.

The configuration of the toner-supplying roller to be used in the present disclosure is described in detail below.

### <Shaft Body>

The shaft body functions as a support member for the toner-supplying roller and an electrode. The shaft body includes an electroconductive material, such as: a metal or an alloy, such as aluminum, a copper alloy, or stainless steel; iron subjected to plating treatment with chromium or nickel; or a synthetic resin having electroconductivity. The shaft body has a solid columnar shape or a hollow cylindrical shape.

### <Resin Layer>

The resin layer preferably contains a polyurethane resin (crosslinked urethane resin) described later as a binder resin from the viewpoint of strength.

In addition, to uniformly supply toner particles to the surface of the developing roller as the toner-supplying roller, the resin layer is preferably a foamed layer having a void that can store the toner particles in the layer. Examples of the void include a large number of through holes and non-through holes. In addition, another example of the void may be a porous form in a state in which bubbles are connected to each other (open cell). The foamed layer containing the crosslinked urethane resin is preferably in an open cell state having a large void. The physical property values of such foamed layer having a void, such as an average cell diameter on the surface thereof, the number of cells thereof, the airflow rate thereof, and the density of the entirety of the layer, are important for the function of the foamed layer. Although the physical property values of the foamed layer are not particularly limited, for example, the foamed layer preferably has values that fall within the following numerical ranges:
average cell diameter on surface: 100 to 500 m;
number of cells: 50 to 300 cells/inch;
airflow rate: 0.5 to 3.0 L/min; and
density: 0.05 to 0.20 g/cm³.

### <Crosslinked Urethane Resin>

The crosslinked urethane resin is a reaction product between a polyol and a compound having an isocyanate group. Examples of the polyol for synthesizing the crosslinked urethane resin of the toner-supplying roller of the present disclosure include a polyester polyol, a polyether polyol, an acrylic polyol, a polycarbonate polyol, and a polycaprolactone polyol. Of those, a polyether polyol is preferred because the crosslinked urethane resin has flexibility.

Examples of the polyether polyol include the following polyols: polyethylene glycol, polypropylene glycol, poly-1,4-butanediol, poly-1,5-pentanediol, polyneopentyl glycol, poly-3-methyl-1,5-pentanediol, poly-1,6-hexanediol, poly-1,8-octanediol, and poly-1,9-nonanediol. Of those, polypropylene glycol, poly-1,4-butanediol, poly-1,5-pentanediol, polyneopentyl glycol, poly-3-methyl-1,5-pentanediol, and poly-1,6-hexanediol are preferred from the viewpoint of suppressing an increase in hardness of the resin layer. In addition, examples of the polyester polyol include the following polyols: polyester polyols obtained by a condensation reaction between diol components, such as ethylene glycol, propylene glycol, 1,4-butanediol, 1,5-pentanediol, neopentyl glycol, 3-methyl-1,5-pentanediol, 1,6-hexanediol, 1,8-octanediol, and 1,9-nonanediol, or triol components such as trimethylolpropane and dicarboxylic acids, such as adipic acid, suberic acid, sebacic acid, phthalic anhydride, terephthalic acid, and hexahydroxyphthalic acid. Of those, polyester polyols obtained by a condensation reaction between diol components, such as propylene glycol, 1,4-butanediol, 1,5-pentanediol, neopentyl glycol, 3-methyl-1,5-pentanediol, and 1,6-hexanediol, and dicarboxylic acids, such as adipic acid, suberic acid, and sebacic acid, are preferred from the viewpoint of suppressing the increase in hardness.

In addition, examples of the polycaprolactone polyol include the following polyols: poly-ε-caprolactone and poly-γ-caprolactone.

In addition, examples of the polycarbonate polyol include the following polyols: polycarbonate polyols obtained by a condensation reaction between diol components, such as ethylene glycol, propylene glycol, 1,4-butanediol, 1,5-pentanediol, neopentyl glycol, 3-methyl-1,5-pentanediol, 1,6-hexanediol, 1,8-octanediol, and 1,9-nonanediol, and dialkyl carbonates, such as phosgene and dimethyl carbonate, or cyclic carbonates such as ethylene carbonate. Of those, polycarbonate polyols obtained by a condensation reaction between diol components, such as neopentyl glycol, 3-methyl-1,5-pentanediol, 1,5-pentanediol, 1,6-hexanediol, and 1,8-octanediol, and dialkyl carbonates such as dimethyl carbonate are preferred from the viewpoint of suppressing the increase in hardness. Those polyol components may be turned into prepolymers subjected to chain extension in advance with an isocyanate compound, such as 2,4-tolylene diisocyanate (TDI), 4,4′-diphenylmethane diisocyanate (MDI), or isophorone diisocyanate (IPDI), as required.

### <Isocyanate Compound>

Although the isocyanate compound is not particularly limited, the following isocyanate compounds may each be used: aliphatic polyisocyanates, such as ethylene diisocyanate and 1,6-hexamethylene diisocyanate (HDI); alicyclic polyisocyanates, such as isophorone diisocyanate (IPDI), cyclohexane-1,3-diisocyanate, and cyclohexane-1,4-diisocyanate; aromatic isocyanates, such as 2,4-tolylene diisocyanate, 2,6-tolylene diisocyanate (TDI), 4,4′-diphenylmethane diisocyanate (MDI), polymeric diphenylmethane diisocyanate, xylylene diisocyanate, and naphthalene diisocyanate; and copolymers, isocyanurate forms, TMP adduct forms, biuret forms, and blocked forms thereof. Of those, aromatic isocyanates, such as tolylene diisocyanate and diphenylmethane diisocyanate, are preferred. It is preferred that the polyol component and the isocyanate compound be mixed so that the ratio (molar ratio) of an isocyanate group in the isocyanate compound falls within the range of from 1.0 to 2.0 with respect to 1.0 of a hydroxy group in the polyol component. When the mixing ratio falls within the above-mentioned range, the remaining of unreacted components can be suppressed.

### <Crosslinking Agent>

The resin layer preferably contains a crosslinking agent as a component for forming the crosslinked urethane resin. Examples of the crosslinking agent include an isocyanate that is trifunctional or more and a polyol that is trifunctional or more, and a crosslinked structure may be formed by using these crosslinking agents. In addition, separately from the foregoing, a known crosslinking agent optimal for the urethane resin may be used. Examples thereof include an amine-based crosslinking agent such as ethylenediamine and an imide-based crosslinking agent such as a carbodiimide.

### <Other Component in Resin Layer>

The resin layer may contain an electroconductive filler as required to the extent that the effects of the present disclosure are not impaired. It is preferred that the resin layer contain an electronic electroconductive filler.

Carbon black and an electroconductive metal, such as aluminum or copper, may each be used as the electroconductive filler. Of those, carbon black is particularly preferably used because the carbon black is relatively easily available, and has a high electroconductivity-imparting property and a high reinforcing property. In the resin layer, a catalyst, a foaming agent, a foam stabilizer, and other aids may be used as required.

The catalyst is not particularly limited, and a catalyst appropriately selected from various hitherto known catalysts may be used. For example, an amine-based catalyst (e.g., triethylenediamine, bis(dimethylaminoethyl) ether, N,N,N′,N′-tetramethylhexanediamine, 1,8-diazabicyclo(5.4.0)undecene-7, 1,5-diazabicyclo(4.3.0)nonene-5, 1,2-dimethylimidazole, N-ethylmorpholine, or N-methylmorpholine), an organometallic catalyst (e.g., tin octylate, tin oleate, dibutyltin dilaurate, dibutyltin diacetate, titanium tetra-i-propoxide, titanium tetra-n-butoxide, or tetrakis(2-ethylhexyloxy)titanium), or an acid salt catalyst obtained by reducing the initial activity of each of the amine-based catalyst and the organometallic catalyst (e.g., a carboxylic acid salt, a formic acid salt, an octylic acid salt, or a boric acid salt) is used. The catalysts may be used alone or in combination thereof.

The foaming agent is not particularly limited, and a foaming agent appropriately selected from various hitherto known foaming agents may be used. In particular, water is suitably used as the foaming agent because the water reacts with a polyisocyanate to generate a carbon dioxide gas. In addition, even when another foaming agent and water are used in combination, the gist of the present disclosure is not impaired.

The foam stabilizer is not particularly limited, and a foam stabilizer appropriately selected from various hitherto known foam stabilizers may be used. As required, a crosslinking aid, a flame retardant, a colorant, a UV absorber, an antioxidant, and the like may be used as the other aids to the extent that the effects of the present disclosure are not impaired.

### [Process Cartridge and Electrophotographic Apparatus]

The process cartridge according to the present disclosure is a process cartridge being detachably attachable onto a main body of an electrophotographic apparatus, and is characterized by including the electrophotographic photosensitive member, the developing roller, and the toner-supplying roller described in the foregoing. In the process cartridge, the developing roller is configured to develop an electrostatic latent image formed on the surface of the photosensitive member, and the toner-supplying roller is arranged in contact with the developing roller and is configured to supply toner to the developing roller.

In addition, an electrophotographic apparatus according to the present disclosure is characterized by including the above-mentioned process cartridge.

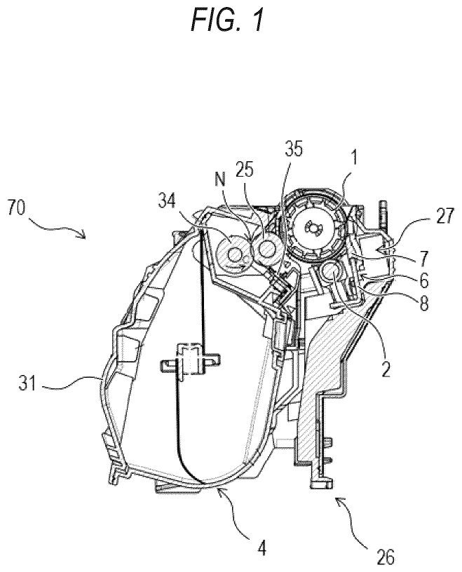

FIG. 1 is an illustration of an example of the main cross-section of a process cartridge 70 including a photosensitive member, a developing roller, and a toner-supplying roller.

The process cartridge 70 includes a photosensitive unit 26 and a developing unit 4. The photosensitive unit 26 includes a photosensitive drum 1, a charging roller 2, and a cleaning member 6. In addition, the developing unit 4 includes a developing roller 25 and a toner-supplying roller 34.

The charging roller 2 and the cleaning member 6 described above are arranged on the periphery of the photosensitive drum 1. The cleaning member 6 includes an elastic member 7 formed of a rubber blade and a cleaning support member 8. The distal end portion of the elastic member 7 is arranged in abutment against the photosensitive drum 1 in a counter direction with respect to the rotation direction thereof. In addition, the toner removed from the surface of the photosensitive drum 1 by the cleaning member 6 falls into a removed toner chamber 27.

The photosensitive drum 1 is rotationally driven in accordance with an image forming operation by transmitting the driving force of a main body drive motor (not shown), which is a drive source, to the photosensitive unit 26.

The charging roller 2 is rotatably mounted on the photosensitive unit 26 through intermediation of a charging roller bearing, is pressurized toward the photosensitive drum 1 by a charging roller-pressurizing member to be brought into abutment against the photosensitive drum 1, and is thus rotated following the rotation of the photosensitive drum 1.

The developing unit 4 includes the developing roller 25 that is rotated in contact with the photosensitive drum 1 and a developing frame 31 that supports the developing roller 25. The toner-supplying roller 34 that is rotated in the direction of the arrow C in contact with the developing roller 25 and a developing blade 35 for regulating a toner layer on the developing roller 25 are each arranged on the periphery of the developing roller 25.

The developing roller 25 and the photosensitive drum 1 are each rotated so that their surfaces move in the same direction in an opposed portion (contact portion). Toner negatively charged by frictional charging against a predetermined DC bias applied to the developing roller 25 is transferred only to a light portion potential portion based on its potential difference in a developing portion that is brought into contact with the photosensitive drum 1, to thereby visualize an electrostatic latent image.

The developing blade 35 is arranged below the developing roller 25 on the drawing sheet in which FIG. 1 is illustrated, and is in abutment against the developing roller 25 in a counter direction to regulate the coat amount of toner supplied by the toner-supplying roller 34 and apply charge to the toner. The developing blade 35 may include a plate member having flexibility and a developing blade support that fixes the plate member. In addition, the developing blade 35 may include an elastic plate formed by using stainless steel (SUS) or the like. The toner is frictionally charged by sliding between the developing blade 35 and the developing roller 25 to be given charge, and is simultaneously regulated for layer thickness. In addition, a predetermined voltage is applied to the developing blade 35 from a blade bias power supply (not shown) to stabilize the toner coat.

The toner-supplying roller 34 is in abutment against the developing roller 25 with a nip portion N. In the present disclosure, the toner-supplying roller 34 and the developing roller 25 are configured so that the movement direction of the surface of the toner-supplying roller 34 in the nip portion N and the movement direction of the surface of the developing roller 25 in the nip portion N are opposite to each other at the time of operation (rotation) (counter configuration). That is, the toner-supplying roller 34 and the developing roller 25 are configured so that the movement direction of the surface of the developing roller 25 is opposite to the movement direction of the surface of the toner-supplying roller 34 at a contact position with the toner-supplying roller 34. The toner-supplying roller 34 and the developing roller 25 are in contact with each other in a predetermined penetration amount, that is, a recessed amount ΔE of a recessed shape in the toner-supplying roller 34 formed by the developing roller 25. It is required that the toner-supplying roller 34 and the developing roller 25 be rotated with the following peripheral velocity difference in directions opposite to each other in the nip portion N. That is, the developing roller 25 and the toner-supplying roller 34 are configured to be rotated while R represented by the following formula (E1) satisfies 1.2≤R≤1.5.

$$R = {V}_{RS} / {V}_{D} \qquad ( E1 )$$

in the formula (E1), VRS represents the absolute value of the peripheral velocity [m/s] of the toner-supplying roller 34, and V_{D} represents the absolute value of the peripheral velocity [m/s] of the developing roller.

Through this operation, toner supply to the developing roller 25 is performed while the residual toner on the developing roller 25 is recovered. In this case, the recovery amount of the residual toner on the developing roller 25 and the supply amount of the toner to the developing roller 25 can be adjusted by adjusting a potential difference between the toner-supplying roller 34 and the developing roller 25.

The toner-supplying roller 34 includes, for example, an electroconductive support serving as a shaft body and a foamed layer supported by the electroconductive support. Specifically, there may be arranged a metal core electrode having an outer diameter of φ5 (mm), the electrode serving as the electroconductive support, and a urethane foamed layer formed around the metal core electrode, the urethane foamed layer serving as the foamed layer including an open-cell foam (open cell) in which bubbles are connected to each other, and the toner-supplying roller 34 is rotated in the direction of the arrow C in the figure at the time of operation. A large amount of the toner is allowed to penetrate into the toner-supplying roller 34 by forming the urethane of the surface layer into an open-cell foam. The resistance of the toner-supplying roller 34 may be, for example, 1×10⁹Ω.

The penetration amount of the toner-supplying roller 34 into the developing roller 25, that is, the recessed amount ΔE of the recessed shape in the toner-supplying roller 34 formed by the developing roller 25 may be set to 1.0 mm.

A method of measuring the resistance of the toner-supplying roller 34 is described below. The toner-supplying roller 34 is brought into abutment against an aluminum sleeve having a diameter of 30 mm so that its penetration amount to be described later is 1.5 mm. The toner-supplying roller 34 is rotated following the aluminum sleeve at 30 rpm by rotating the aluminum sleeve.

Next, a DC voltage of −50 V is applied to the developing roller 25. In this case, a resistor of 10 kΩ is arranged on the ground side and a current is calculated by measuring a voltage across the resistor. Thus, the resistance of the toner-supplying roller 34 is calculated. The surface cell diameter of the toner-supplying roller 34 may be set to, for example, 50 to 1,000 μm.

Herein, the cell diameter refers to the average diameter of foamed cells in an arbitrary cross-section. The average diameter is obtained by first measuring the area of the largest foamed cell from the enlarged image of the arbitrary cross-section, converting the area into a diameter equivalent to a perfect circle to provide a maximum cell diameter, then removing the foamed cells each having a cell diameter equal to or less than ½ of the maximum cell diameter as noise, and then converting the remaining individual cell areas into individual cell diameters in the same manner to provide an average thereof.

The toner supplied from the toner-supplying roller 34 to the surface of the developing roller 25 is frictionally charged by sliding between the developing blade 35 and the developing roller 25 to be given charge, and is simultaneously regulated for layer thickness. After that, the toner is conveyed to the abutment portion (developing portion) between the photosensitive drum 1 and the developing roller 25, and is transferred only to the light portion potential portion. The residual toner remaining on the surface of the developing roller 25 is returned into a developing container again and is recovered from the surface of the developing roller 25 by the toner-supplying roller 34 to be stored in the toner-supplying roller 34.

A configuration for driving the developing roller 25 and the toner-supplying roller 34 preferably includes a driving force-receiving portion, a first driving force-transmitting portion, and a second driving force-transmitting portion. In this case, the driving force-receiving portion is configured to receive a driving force for driving the toner-supplying roller 34. In addition, the first driving force-transmitting portion is configured to transmit the driving force received by the driving force-receiving portion to the toner-supplying roller 34. In addition, the second driving force-transmitting portion is configured to transmit a driving force generated by drive of the toner-supplying roller 34 to the developing roller 25. When the rotational drive of the developing roller 25 is indirectly performed through the second driving force-transmitting portion in response to the input of a driving force from the outside, the second driving force-transmitting portion absorbs an abrupt frictional force fluctuation and suppresses the coat amount of the toner on the developing roller 25 from becoming unstable (reference patent literature: Japanese Patent Application Laid-Open No. 2014-134787). Specifically, the developing roller 25 is in contact with both the toner-supplying roller 34 and the photosensitive drum 1, and hence any abrupt frictional force fluctuation that has occurred between the developing roller 25 and the photosensitive drum 1 influences the rotation of the toner-supplying roller 34 that is in contact with the developing roller 25. In addition, the coat amount of the toner supplied onto the developing roller 25 by the toner-supplying roller 34 may become unstable. In the above-mentioned preferred configuration, the toner-supplying roller 34 is first driven by the input of a driving force from the outside, and then the developing roller 25 is driven through the second driving force-transmitting portion. Thus, even when an abrupt frictional force fluctuation occurs between the developing roller 25 and the photosensitive drum 1, the toner-supplying roller 34 is driven with a driving force from the outside that is not influenced by the frictional force fluctuation, and the second driving force-transmitting portion absorbs the frictional force fluctuation. As a result, the toner-supplying roller 34 can stably supply the toner to the developing roller 25. The above-mentioned configuration that suppresses the phenomenon in which the abrupt frictional force fluctuation makes the coat amount of the toner unstable is suitable for suppressing banding at the time of repeated use in the present disclosure. The second driving force-transmitting portion may include a third driving force-transmitting portion, a fourth driving force-transmitting portion, and a fifth driving force-transmitting portion. In this case, the third driving force-transmitting portion is arranged in the end portion of the shaft body of the toner-supplying roller 34 and is configured to transmit a driving force generated by drive of the toner-supplying roller 34 to the fourth driving force-transmitting portion. In addition, the fourth driving force-transmitting portion is configured to transmit the driving force to the fifth driving force-transmitting portion by being driven with the driving force received from the third driving force-transmitting portion. In addition, the fifth driving force-transmitting portion is arranged in the end portion of the mandrel of the developing roller 25 and is configured to receive the driving force from the fourth driving force-transmitting portion to drive the developing roller 25.

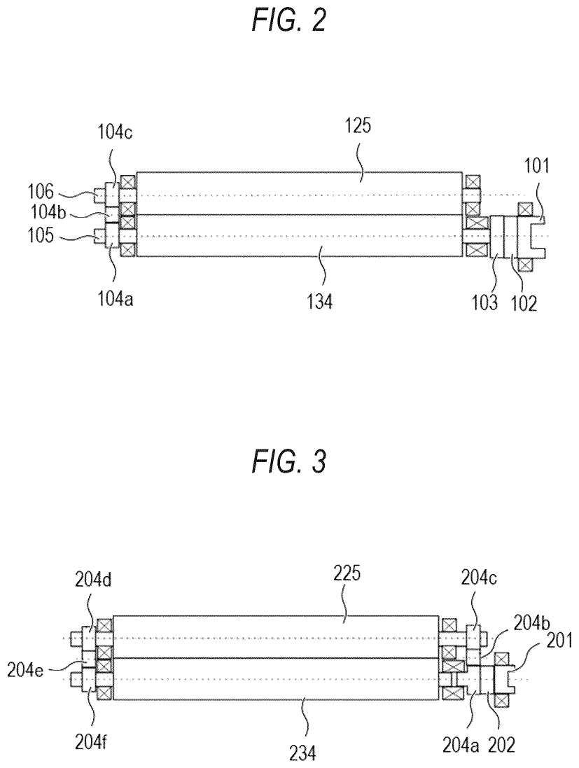

FIG. 2 is a schematic view for illustrating a specific example of a preferred configuration for driving the developing roller and the toner-supplying roller described above.

A driving force input to a coupling (driving force-receiving portion) 101 is transmitted to a driving force-transmitting member 103 through an intermediate 102 to drive a toner-supplying roller 134 rotationally. In this case, the combination of the intermediate 102 and the driving force-transmitting member 103 corresponds to the first driving force-transmitting portion described above. The rotational driving force transmitted to the toner-supplying roller 134 is transmitted to a gear (third driving force-transmitting portion) 104a, a gear (fourth driving force-transmitting portion) 104b, and a gear (fifth driving force-transmitting portion) 104c in this order to drive a developing roller 125 rotationally. In this case, the configuration formed of the combination of the gear 104a, the gear 104b, and the gear 104c corresponds to the second driving force-transmitting portion described above. That is, the gear 104a is arranged in the end portion of a shaft body 105 of the toner-supplying roller 134, and transmits a driving force generated by drive of the toner-supplying roller 134 to the gear 104b. Subsequently, the gear 104b is driven with the driving force received from the gear 104a to transmit the driving force to the gear 104c. In addition, the gear 104c is arranged in the end portion of a mandrel 106 of the developing roller 125, and receives the driving force from the gear 104b to drive the developing roller 125. As a result, the driving force generated by drive of the toner-supplying roller 134 is transmitted to the developing roller 125. In the example illustrated in FIG. 2, there is looseness in intermeshing portions among the gear 104a, the gear 104b, and the gear 104c, and hence the abrupt frictional force fluctuation that has occurred between the developing roller 125 and the photosensitive drum can be absorbed. In addition, the driving force transmitted from the outside to the toner-supplying roller 134 through the coupling 101, the intermediate 102, and the driving force-transmitting member 103 is not influenced by such frictional force fluctuation, and hence the toner-supplying roller 134 is stably driven. As a result, a fluctuation in supply amount of the toner from the toner-supplying roller 134 to the developing roller 125 can be suppressed.

The specific configuration of the second driving force-transmitting portion is not limited to the configuration formed of the combination of the gear 104a, the gear 104b, and the gear 104c illustrated in FIG. 2. The specific configuration of the second driving force-transmitting portion may be a configuration using any mechanism as long as the configuration is capable of transmitting the driving force generated by drive of the toner-supplying roller 134 to the developing roller 125.

In the preferred configuration for driving the developing roller 125 and the toner-supplying roller 134 described above, the above-mentioned R needs to satisfy 1.2≤R≤1.5. To that end, it is only required that the toner-supplying roller 134, the second driving force-transmitting portion, and the developing roller 125 be driven to be coupled. That is, when the radius of the developing roller 125 is represented by r_{D} [mm] and the radius of the toner-supplying roller 134 is represented by r_{RS} [mm], it is only required that the above-mentioned respective members be driven to be coupled so that λ represented by the following formula (E2) satisfies 1.2≤λ×r_{RS}/r_{D}≤1.5. In this case, λ represented by the above-mentioned formula (E2) represents the ratio of a rotational angular velocity with respect to the radius r_{D} of the developing roller 125 and the radius r_{RS} of the toner-supplying roller 134:

$$λ = {ω}_{RS} / {ω}_{D} \qquad ( E2 )$$

in the formula (E2), ω_{RS} represents the rotational angular velocity [rad/s] of the toner-supplying roller 134, and ω_{D} represents the rotational angular velocity [rad/s] of the developing roller 125.

As an example, in the specific configuration illustrated in FIG. 2, it is only required that the three gear ratios of the gear 104a, the gear 104b, and the gear 104c be set so that the λ satisfies 1.2≤λ×r_{RS}/r_{D}≤1.5.

In addition, FIG. 3 is a schematic view for illustrating another example of the configuration for driving the developing roller and the toner-supplying roller.

A driving force input to a coupling 201 is transmitted to a gear 204a through an intermediate 202, and is transmitted to a gear 204b and a gear 204c in this order to drive a developing roller 225 rotationally. The rotational driving force is transmitted to a gear 204d, a gear 204e, and a gear 204f in this order to drive a toner-supplying roller 234 rotationally.

In the present disclosure, from the viewpoint of suppressing an increase in dynamic friction coefficient between the developing roller and the photosensitive member caused by a change in surface of the developing roller, the above-mentioned R preferably satisfies 1.2≤R≤1.3.

The process cartridge according to the present disclosure may be used in, for example, a laser beam printer, an LED printer, a copying machine, a facsimile, and a multifunctional peripheral thereof.

According to the present disclosure, there can be provided the process cartridge capable of forming an electrophotographic image of high quality by stabilizing the toner supply amount from the toner-supplying roller to the developing roller and suppressing the occurrence of a banding image caused by an increase in dynamic friction coefficient between the developing roller and the photosensitive member.

### EXAMPLES

The present disclosure is described in more detail below by way of Examples and Comparative Examples. The present disclosure is by no means limited to the following Examples as long as a modification thereof does not depart from the gist of the present disclosure. In the description of the following Examples, the term “part(s)” is “part(s) by mass” unless otherwise specified.

### <Production of Electrophotographic Photosensitive Member>

### <Production of Photosensitive Member 1>

### (Support)

A cylinder formed of a cut aluminum alloy having an outer diameter of 24 mm, a length of 257 mm, and a thickness of 0.75 mm was used as a support.

### (Formation of Undercoat Layer)

100 Parts of rutile-type titanium oxide particles (product name: MT-600B, average primary particle diameter: 50 nm, manufactured by Tayca Corporation) were stirred and mixed with 500 parts of toluene, and 5.0 parts of vinyltrimethoxysilane (product name: KBM-1003, manufactured by Shin-Etsu Chemical Co., Ltd.) was added to the mixture, followed by stirring for 8 hours. After that, toluene was evaporated by distillation under reduced pressure, and the residue was dried at 120° C. for 3 hours. Thus, rutile-type titanium oxide particles whose surfaces had already been treated with vinyltrimethoxysilane were obtained.

Subsequently, the following materials were prepared.
The above-mentioned rutile-type titanium oxide particles whose surfaces had already been treated with vinyltrimethoxysilane: 18 parts
N-Methoxymethylated nylon (product name: TORESIN EF-30T, manufactured by Nagase ChemteX Corporation): 4.5 parts
A copolymerized nylon resin (product name: AMILAN (trademark) CM8000, manufactured by Toray Industries, Inc.): 1.5 parts

Those materials were added to a mixed solvent of 90 parts of methanol and 60 parts of 1-butanol to prepare a dispersion liquid. The dispersion liquid was subjected to dispersion treatment for 5 hours with a vertical sand mill through use of glass beads each having a diameter of 1.0 mm to prepare a coating liquid for an undercoat layer.

The coating liquid for an undercoat layer was applied onto the above-mentioned support by dip coating to form a coating film, and the coating film was dried at 100° C. for 10 minutes to form an undercoat layer having a thickness of 2.00 μm.

### (Formation of Charge Generating Layer)

10 Parts of a Y-type oxytitanium phthalocyanine crystal having a strong peak at a Bragg angle (2θ±0.2°) in CuKα characteristic X-ray diffraction of 27.3° was prepared as a charge generating substance. 10 Parts of the Y-type oxytitanium phthalocyanine crystal and 150 parts of 4-methoxy-4-methylpentanone-2 were loaded into a sand mill using glass beads each having a diameter of 1 mm, and were subjected to pulverization and dispersion treatment with a sand grind mill for 1.5 hours.

Next, 105 parts of a solution obtained by adding and dissolving 5 parts of a polyacetal resin (product name: S-LEC BX-1, manufactured by Sekisui Chemical Co., Ltd.) in 100 parts of 4-methoxy-4-methylpentanone-2 in advance was added, and the resultant mixture was subjected to dispersion treatment for 0.5 hour.

After that, 250 parts of 1,2-dimethoxyethane was added to the mixture to prepare a coating liquid for a charge generating layer. The coating liquid for a charge generating layer was applied onto the resultant undercoat layer by dip coating to form a coating film, and the coating film was dried at 100° C. for 10 minutes to form a charge generating layer having a thickness of 0.15 μm.

X-Ray diffraction measurement was performed under the following conditions.

### [Powder X-Ray Diffraction Measurement]

Measurement apparatus used: X-ray diffraction apparatus RINT-TTR II manufactured by Rigaku Denki Co., Ltd.
X-ray tube bulb: Cu
Tube voltage: 50 KV
Tube current: 300 mA
Scan method: 2θ/θ scan
Scan speed: 4.0°/min
Sampling interval: 0.02°
Start angle (20): 5.0°
Stop angle (20): 40.0°
Attachment: standard sample holder
Filter: not used
Incident monochrometer: used
Counter monochrometer: not used
Divergent slit: open
Divergent longitudinal restriction slit: 10.00 mm
Scattering slit: open
Light receiving slit: open
Flat sheet monochrometer: used
Counter: scintillation counter

### (Formation of Surface Layer (Charge Transporting Layer))

Next, the following materials were prepared.
Charge transporting substance represented by the following formula (CTM1): 56 parts
Charge transporting substance represented by the following formula (CTM2): 26 parts
Charge transporting substance represented by the following formula (CTM3): 5 parts
Polyarylate resin having a molar ratio between a structural unit represented by the following formula (A1−1) and a structural unit represented by the following formula (A2-1) of 1.2:0.9:30 parts
Polycarbonate resin including a structural unit represented by the following formula (A3): 70 parts

Those materials were dissolved in a mixed solvent of 23 parts of ortho-xylene, 23 parts of methyl benzoate, and 23 parts of dimethoxymethane to prepare a coating liquid for a surface layer. The coating liquid for a surface layer was applied onto the charge generating layer by dip coating to form a coating film, and the coating film was dried at 125° C. for 30 minutes to form a surface layer having a thickness of 15 μm.

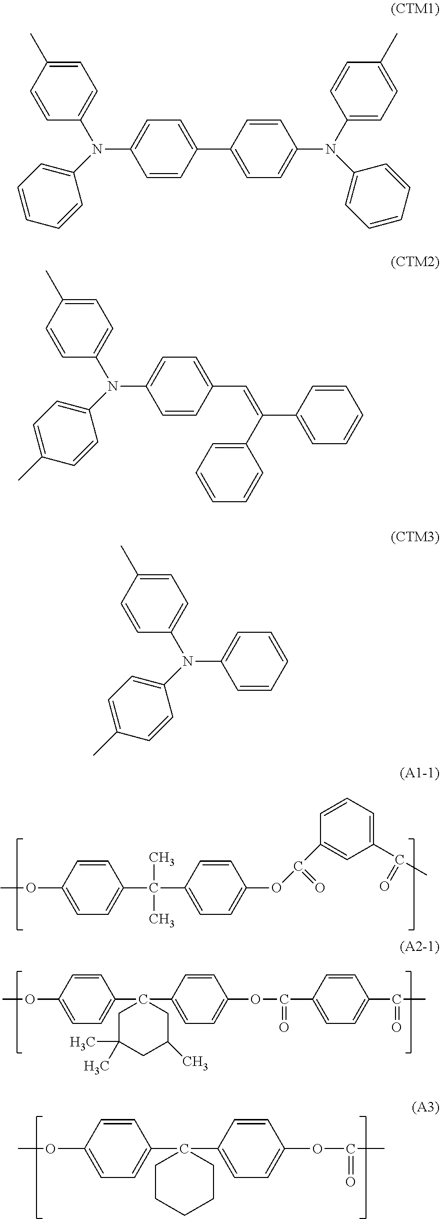

### (Analysis of Surface Layer of Electrophotographic Photosensitive Member)

Through the ¹H-nuclear magnetic resonance analysis in deuterated chloroform of a polymer component recovered from the surface layer of the resultant photosensitive member, a ¹H-NMR spectrum was obtained. The resultant ¹H-NMR spectrum had peaks at 8.97±0.02 ppm, 8.43±0.02 ppm, 7.67±0.02 ppm, 8.30±0.02 ppm, 1.71±0.03 ppm, 0.42±0.02 ppm, and 1.01±0.02 ppm. As a result, it was recognized that the surface layer of the photosensitive member included the structural unit represented by the formula (A1) and the structural unit represented by the formula (A2).

In addition, the integral value at 1.71±0.03 ppm, the integral value at 1.01±0.02 ppm, and the integral value at 8.30±0.02 ppm were calculated from the ¹H-NMR spectrum, and were each divided by the number of protons. When the integral value per proton (hereinafter referred to as “1H”) at 8.30±0.02 ppm was set to 1, a ratio between the integral value per 1H at 1.71±0.03 ppm and the integral value per 1H at 1.01±0.02 ppm was calculated. The ratio thus calculated was defined as the molar ratio between the structural unit represented by the formula (A1) and the structural unit represented by the formula (A2) in the surface layer. The molar ratio between the structural unit represented by the formula (A1) and the structural unit represented by the formula (A2) in the surface layer of the photosensitive member 1 was 1.2:0.9 (structural unit represented by the formula (A1):structural unit represented by the formula (A2)).

The integral value at 2.25±0.02 (pk1) ppm indicating the polycarbonate resin including the structural unit represented by the formula (A3) was calculated from the ¹H-NMR spectrum. In addition, the integral values at 1.71±0.03 (pk2) ppm, 1.01±0.02 (pk3) ppm, 8.30±0.02 ppm, 8.43±0.02 (pk4) ppm, and 8.97±0.02 (pk5) ppm were calculated. An integral value per 1H was calculated by dividing each of those calculated values by the number of protons. The ratio of the pk2 to pk5 when the integral value per 1H of each of the pk1 to pk5 was multiplied by the molecular weight of each resin, and the total of the pk1 to pk5 was set to 100% was defined as the content ratio (mass %) of the polyarylate resin with respect to the total mass of the surface layer. The content ratio of the polyarylate resin with respect to the total mass of the surface layer of the photosensitive member 1 in the surface layer was 20 mass %.

### <Production of Photosensitive Members 2 to 15>

Photosensitive members 2 to 15 were produced in the same manner as in the photosensitive member 1 except that the kinds of materials and the mixing ratios thereof were appropriately adjusted to be changed so that surface layers having configurations shown in Table 1 were obtained in the formation of surface layers of the photosensitive members 2 to 15.

### <Production of Photosensitive Member 16>

A photosensitive member 16 was produced in the same manner as in the photosensitive member 1 except that the polycarbonate resin including the structural unit represented by the formula (A3) was changed to a polycarbonate resin including a structural unit represented by the following formula (A4) in the formation of the surface layer of the photosensitive member 1.

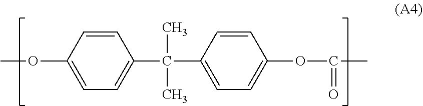

TABLE 1

| | | | | Content mass [%] of |
|---|---|---|---|---|
| | | | | polyarylate resin |
| | | | Molar ratio | including structural |
| | Structural unit | | between | units (A1) and (A2) |
| | of resin | | (A1) and (A2) | with respect to |
| | (A1) | (A2) | (A1):(A2) | surface layer |
| Photosensitive | (A1-1) | (A2-1) | 1.2:0.9 | 16 |
| member 1 | | | | |
| Photosensitive | (A1-1) | (A2-1) | 1.2:0.9 | 30 |
| member 2 | | | | |
| Photosensitive | (A1-1) | (A2-1) | 1.2:0.9 | 50 |
| member 3 | | | | |
| Photosensitive | (A1-1) | (A2-1) | 1.4:0.7 | 50 |
| member 4 | | | | |
| Photosensitive | (A1-1) | (A2-1) | 1.4:0.7 | 30 |
| member 5 | | | | |
| Photosensitive | (A1-1) | (A2-1) | 1.4:0.7 | 16 |
| member 6 | | | | |
| Photosensitive | (A1-1) | (A2-2) | 1.2:0.9 | 16 |
| member 7 | | | | |
| Photosensitive | (A1-2) | (A2-1) | 1.2:0.9 | 16 |
| member 8 | | | | |
| Photosensitive | (A1-2) | (A2-2) | 0.9:1.2 | 16 |
| member 9 | | | | |
| Photosensitive | (A1-2) | (A2-2) | 1.5:0.6 | 16 |
| member 10 | | | | |
| Photosensitive | (A1-2) | (A2-2) | 0.5:1.6 | 16 |
| member 11 | | | | |
| Photosensitive | (A1-2) | (A2-2) | 1.8:0.3 | 16 |
| member 12 | | | | |
| Photosensitive | (A1-2) | (A2-2) | 1.0:1.1 | 14 |
| member 13 | | | | |
| Photosensitive | (A1-2) | (A2-2) | 1.0:1.1 | 10 |
| member 14 | | | | |
| Photosensitive | (A1-2) | (A2-2) | 1.0:1.1 | 16 |
| member 15 | | | | |
| Photosensitive | (A1-1) | (A2-1) | 1.2:0.9 | 16 |
| member 16 | | | | |

The (A1−2) and (A2−2) shown in Table 1 are a structural unit represented by the following formula (A1−2) and a structural unit represented by the following formula (A2−2), respectively.

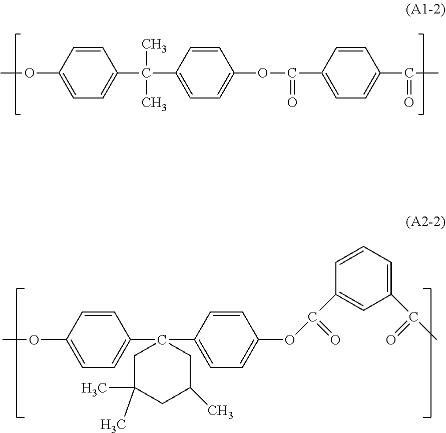

### <Production of Photosensitive Member 17>

A photosensitive member 17 was produced in the same manner as in the photosensitive member 1 except that a coating liquid for a surface layer was prepared as described below in the formation of the surface layer of the photosensitive member 1.

The following materials were prepared.
Charge transporting substance represented by the formula (CTM1): 56 parts
Charge transporting substance represented by the formula (CTM2): 26 parts
Charge transporting substance represented by the formula (CTM3): 5 parts
Polyarylate resin formed of a structural unit represented by the formula (A5): 100 parts

Those materials were dissolved in a mixed solvent of 23 parts of ortho-xylene, 23 parts of methyl benzoate, and 23 parts of dimethoxymethane to prepare a coating liquid for a charge transporting layer.

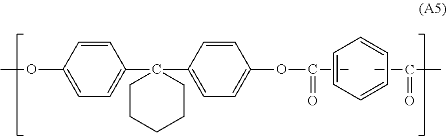

### <Production of Developing Roller 1>

### (Preparation of Substrate)

A mandrel made of stainless steel (SUS304) having an outer diameter of 6 mm and a length of 270 mm was prepared, and an electroconductive vulcanizing adhesive (product name: METALOC U-20, manufactured by Toyokagaku Kenkyusho Co., Ltd.) was applied to the circumferential surface of the mandrel, followed by baking. Thus, a mandrel serving as a substrate was prepared.

### (Formation of First Elastic Layer)

Materials for an elastic layer shown in Table 2 were mixed at a filling ratio of 70 vol % and a blade rotation speed of 30 rpm for 16 minutes with a 6-liter pressure kneader (product name: TD6−15MDX, manufactured by TOSHIN Co., Ltd.) to provide a mixture A.

TABLE 2

| | Part(s) |
|---|---|
| Material | by mass |
| Acrylonitrile-butadiene rubber (NBR) | 60 |
| (product name: N230SV, manufactured by | |
| JSR Corporation) | |
| Epichlorohydrin rubber | 40 |
| (product name: EPION 301, manufactured | |
| by Osaka Soda Co., Ltd.) | |
| Zinc oxide (particle diameter: 0.28 μm, | 5 |
| manufactured by Sakai Chemical | |
| Industry Co., Ltd.) | |
| Calcium carbonate | 20 |
| (product name: NANOX #30, manufactured | |
| by Maruo Calcium Co., Ltd.) | |
| Carbon black | 40 |
| (product name: TOKABLACK #7400, | |
| manufactured by Tokai Carbon Co., Ltd.) | |

Then, materials shown in Table 3 were bilaterally cut 20 times in total at a front roll rotation speed of 10 rpm, a back roll rotation speed of 8 rpm, and a roll gap of 2 mm with an open roll having a roll diameter of 12 inches (0.30 m). After that, the resultant was subjected to tight milling 10 times at a roll gap of 0.5 mm to provide a mixture B.

TABLE 3

| | Part(s) |
|---|---|
| Material | by mass |
| Mixture A | 200 |
| Sulfur | 1.2 |
| Tetrabenzylthiuram disulfide | 4.5 |
| (product name: NOCCELER TBzTD, | |
| manufactured by Ouchi Shinko | |
| Chemical Industrial Co., Ltd.) | |

Next, the above-mentioned mixture B was extruded simultaneously with the mandrel while being molded into a cylindrical shape coaxially around the mandrel by extrusion molding using a crosshead. Thus, a layer of the mixture B was formed on the outer peripheral surface of the mandrel. An extruder having a cylinder diameter of 45 mm (ΦD45) and an L/D of 20 was used as an extruder, and the temperatures of a head, a cylinder, and a screw at the time of the extrusion were adjusted to 90° C., 90° C., and 90° C., respectively. Both the end portions of the layer of the mixture B in the longitudinal direction of the mandrel were cut so that the length of the layer of the mixture B in the longitudinal direction of the mandrel was set to 237 mm.

After that, the mandrel was heated in an electric furnace at a temperature of 160° C. for 40 minutes so that the layer of the mixture B was vulcanized. Thus, a vulcanized member was formed. Subsequently, the surface of the vulcanized member was polished with a polishing machine of a plunge-cut grinding mode. Thus, a roller in which a first elastic layer having a thickness of 3.0 mm was formed on the outer periphery of a metal core was obtained.

### (Formation of Second Elastic Layer)

Materials except roughness-forming particles in Table 4 were stirred and mixed as materials for a second elastic layer. After that, the materials were dissolved in methyl ethyl ketone (manufactured by Kishida Chemical Co., Ltd.) so that their solid content concentration was 30 mass %, and the materials were mixed, followed by uniform dispersion with a sand mill. Methyl ethyl ketone was added to the mixed liquid to adjust the solid content concentration to 25 mass %, and a material shown in the “Roughness-forming particles” column of Table 4 was added to the resultant mixture, followed by stirring and dispersion with a ball mill. Thus, a coating liquid for a second elastic layer was obtained. The coating liquid was applied to the roller having the first elastic layer formed thereon by dipping the roller into the coating liquid so that the thickness of the second elastic layer was about 15 μm. After that, the coating film was dried and cured by heating at a temperature of 135° C. for 60 minutes to form the second elastic layer. Thus, a developing roller 1 was obtained.

TABLE 4

| | Part(s) |
|---|---|
| Material | by mass |
| Polyether polyol | 100 |
| (product name: PTGL1000, manufactured by | |
| Hodogaya Chemical Co., Ltd.) | |
| Polymeric MDI | 36.0 |
| (product name: MR-400, manufactured by | |
| Tosoh Corporation) | |
| Carbon black | 29.3 |
| (product name: SUNBLACK X15, | |
| manufactured by Asahi Carbon Co., Ltd.) | |
| Polyether monool | 3.0 |
| (product name: Newpol 50HB100, | |
| manufactured by Sanyo Chemical Industries, | |
| Ltd.) | |
| Modified silicone oil | 0.6 |
| (product name: TSF4445, manufactured by | |
| Momentive Performance Materials Japan LLC) | |
| Roughness-forming particles | 104 |
| (product name: DAIMIC BEAZ UCN-5090, | |
| manufactured by Dainichiseika | |
| Color & Chemicals Mfg. Co., Ltd.) | |

### (Analysis of Developing Roller 1)

The developing roller was left to stand under an environment at a temperature of 23° C. and a relative humidity of 53% for 24 hours. Next, the hardness of the developing roller was measured with a microrubber hardness meter (product name: MD-1capa, manufactured by Kobunshi Keiki Co., Ltd.) and an indenter having a diameter of 0.16 mm at each of 12 points determined as follows: the central portion of the developing roller and positions distant inward from both the end portions thereof by 20 mm each were determined, and four points were determined in each of the three portions in increments of 90° in the circumferential direction thereof. The average of those measured values was adopted as an MD-1 hardness. The developing roller 1 showed an MD-1 hardness of 50°.

### <Production of Developing Roller 2>

A developing roller 2 was produced in the same manner as in the developing roller 1 except that the amount of the carbon black to be used for preparing the mixture A was changed to 30 parts by mass in the formation of the first elastic layer. The MD-1 hardness of the surface of the resultant developing roller 2 is shown in Table 6.

### <Production of Developing Roller 3>

A developing roller 3 was produced in the same manner as in the developing roller 1 except that the amount of zinc oxide to be used for preparing the mixture A was changed to 14 parts by mass in the formation of the first elastic layer. The MD-1 hardness of the surface of the resultant developing roller 3 is shown in Table 6.

### <Production of Developing Roller 4>

A developing roller 4 was produced in the same manner as in the developing roller 1 except that the formation method of the first elastic layer was changed as described below. The MD-1 hardness of the surface of the resultant developing roller 4 is shown in Table 6.

### (Formation of First Elastic Layer)

As materials for the first elastic layer, an addition-type silicone rubber composition obtained by mixing materials shown in Table 5 with a kneader (product name: Trimix TX-15, manufactured by Inoue Mfg., Inc.) was injected into a mold heated to a temperature of 115° C. After the injection of the materials, the materials were molded while being heated at a temperature of 120° C. for 10 minutes, and the resultant was cooled to room temperature. Then, the resultant was removed from the mold to provide a roller having a first elastic layer with a thickness of 3.0 mm formed on the outer periphery of a metal core.

TABLE 5

| | Part(s) by |
|---|---|
| Material | mass |
| Liquid dimethylpolysiloxane | 100 |
| (product name: DMS-V46, | |
| viscosity: 60,000 cP, | |
| manufactured by Gelest, Inc.) | |
| Platinum-based catalyst | 0.048 |
| (product name: SIP6832.2, | |
| manufactured by Gelest, Inc.) | |
| Dimethylpolysiloxane | 2 |
| (product name: HMS-501, | |
| manufactured by Gelest, Inc.) | |
| Carbon black | 6 |
| (product name: TOKABLACK | |
| #7360SB, manufactured | |
| by Tokai Carbon Co., Ltd.) | |

### <Production of Developing Roller 5>

A developing roller 5 was produced in the same manner as in the developing roller 4 except that dimethylpolysiloxane out of the materials for the first elastic layer was changed to HMS-082 (manufactured by Gelest, Inc.) and the amount of the HMS-082 to be used was set to 3 parts by mass. The MD-1 hardness of the surface of the resultant developing roller 5 is shown in Table 6.

<Production of Developing Roller 6>

A developing roller 6 was produced in the same manner as in the developing roller 4 except that dimethylpolysiloxane out of the materials for the first elastic layer was changed to HMS-082 (manufactured by Gelest, Inc.) and the amount of the HMS-082 to be used was set to 6 parts by mass. The MD-1 hardness of the surface of the resultant developing roller 6 is shown in Table 6.

TABLE 6

| | MD-1 hardness [°] |
|---|---|
| Developing roller 1 | 50 |
| Developing roller 2 | 45 |
| Developing roller 3 | 55 |
| Developing roller 4 | 37 |
| Developing roller 5 | 20 |
| Developing roller 6 | 23 |

### <Production of Toner-Supplying Roller 1>

A primer (product name: DY39-012, manufactured by Dow Corning Toray Co., Ltd.) was applied to a metal core made of stainless steel (SUS304) having a diameter of 5 mm, followed by baking, to prepare a shaft body.

In addition, a urethane rubber composition obtained by blending the following materials (A) to (F) and mixing the blended materials was foamed by a mechanical frothing method to produce a polyurethane foam.

The polyurethane foam was cut out into a 19-millimeter square rectangular parallelepiped shape having a length of 220 mm, and a shaft body insertion hole having a diameter of ω5 mm was formed at the center of the 19-millimeter square surface along a longitudinal direction.

The shaft body was press-fitted into the shaft body insertion hole, and the shaft body and the polyurethane foam were bonded to each other by heat welding.

After that, the outer periphery of the polyurethane foam was polished with a traverse-type processing machine to produce an electroconductive roll having an outer diameter of 13 mm.
(A): Carbon black (Ketjen Black 600JD): 5.0 parts by mass
(B): Polyol A (polyethylene propylene ether triol having a number average molecular weight of 2,000, product name: ACTCOL EP-550N, manufactured by Mitsui Chemicals, Inc.): 100.0 parts by mass
(C): Polyisocyanate mixture (NCO %=45, MDI=20% content, product name: COSMONATE TM20, manufactured by Mitsui Chemicals, Inc.): 24.4 parts by mass
(D): Silicone foam stabilizer (product name: SRX274C, manufactured by Dow Corning Toray Silicone Co., Ltd.): 1.0 part by mass
(E): Tertiary amine catalyst A (mixture of bis(2-dimethylaminoethyl) ether and dipropylene glycol, product name: TOYOCAT-ET, manufactured by Tosoh Corporation): 0.3 part by mass
(F): Amine catalyst B (product name: TOYOCAT-L33, manufactured by Tosoh Corporation): 0.2 part by mass

### <Production of Toner-supplying Roller 2>

A primer (product name: DY39−012, manufactured by Dow Corning Toray Co., Ltd.) was applied to a metal core made of stainless steel (SUS304) having a diameter of 5 mm, followed by baking, to prepare a shaft body.

In addition, the following materials (A) to (D) were blended and sufficiently kneaded with a two-spindle roll to provide a rubber composition.
(A): Millable-type silicone rubber (KE-3601SB-U, manufactured by Shin-Etsu Chemical Co., Ltd.): 100 parts by mass
(B): White catalyst (C-25A, manufactured by Shin-Etsu Chemical Co., Ltd.): 1.0 part by mass
(C): Crosslinking agent (C-25B, manufactured by Shin-Etsu Chemical Co., Ltd.): 2.5 parts by mass
(D): Chemical foaming agent (AIBN, manufactured by Otsuka Chemical Co., Ltd.): 10 parts by mass

The shaft body and the rubber composition were extruded in one piece with an extrusion molding machine, and the rubber composition was primarily vulcanized by heating at 230° C. for 20 minutes in an infrared heating furnace, followed by secondary vulcanization at 230° C. over 7 hours in a hot air drying furnace. Thus, a roller base body having a foamed layer was produced. The outer periphery of the roller base body was polished with a traverse-type processing machine to produce an electroconductive roll having an outer diameter of 13 mm.

### <Production of Toner-supplying Roller 3>

A toner-supplying roller 3 was produced in the same manner as in the toner-supplying roller 1 except that the electroconductive filler was changed from carbon black to an ionic electroconductive material (lithium N,N-bis(trifluoromethanesulfonyl)imide (product name: EF-N115, manufactured by Mitsubishi Materials Electronic Chemicals Co., Ltd.); 5 parts by mass).

### Evaluation

### <Evaluation of Fluctuation in Dynamic Friction Coefficient (Evaluation (1))>

The dynamic friction coefficient between a developing roller and an electrophotographic photosensitive member was measured with a surface property measuring device (product name: Heidon: Type 14, manufactured by Shinto Scientific Co., Ltd.), and a fluctuation in dynamic friction coefficient was evaluated. A jig of the measuring device was modified so that the developing roller was able to be brought into abutment against the electrophotographic photosensitive member, and a vertical load of 60 g was applied with a weight. A dynamic friction coefficient was measured by rotating the electrophotographic photosensitive member at a speed of 310 rpm with a mechanism that rotatably supported the electrophotographic photosensitive member, which was prepared separately from the measuring device.

The fluctuation in dynamic friction coefficient was calculated as a change ratio B/A×100 of the dynamic friction coefficient in the presence or absence of an increase in temperature when the dynamic friction coefficient measured in the developing roller at room temperature was represented by A and the dynamic friction coefficient measured in the developing roller heated to a surface temperature of 40° C. assuming an increase in temperature was represented by B.

<Evaluation of Occurrence Situation of Banding Image after Repeated Use Under Room Temperature Environment (Evaluation (2))>

A charging potential and an exposure potential were set to −550 V and −100 V, respectively, under an environment at a temperature of 23° C. and a relative humidity of 50%, and 10,000 sheets were continuously passed so that a halftone image drawing horizontal lines with a width of one dot and intervals of two dots in a direction perpendicular to the rotation direction of the photosensitive member was printed on the sheets. In this case, a reconstructed machine of a laser beam printer manufactured by Hewlett-Packard Company may be used as an electrophotographic apparatus. Specific examples thereof include reconstructed machines of Color Laser Jet Enterprise M653dn (product name), Color Laser Jet Enterprise M553dn (product name), and Color Laser Jet CP4525dn (product name). The evaluation was performed by visually observing the occurrence situation of streak-like unevenness in the halftone images, and the determination was performed based on the following criteria.

### Evaluation Criteria

A: No horizontal streak-like unevenness is observed.
B: Horizontal streak-like unevenness is slightly observed.
C: Horizontal streak-like unevenness is observed at the position corresponding to the rotation pitch of the charging roller.
D: Horizontal streak-like unevenness is significantly observed.
   <Evaluation of Occurrence Situation of Banding Image after Repeated Use Under Low-Temperature and Low-Humidity Environment (Evaluation (3))>

In the same manner as in Evaluation (2), a paper passing endurance test of 10,000 sheets was performed under a low-temperature and low-humidity environment (temperature: 15° C., relative humidity: 10%). After the passage of the 10,000 sheets, the images were evaluated in the same manner as in Evaluation (2), and the determination was performed based on the above-mentioned criteria.

### Example 1

The electrophotographic photosensitive member 1 and the developing roller 1 produced as described above were mounted on Heidon: Type 14 modified, and Evaluation (1) was performed.

In a process cartridge, a counter configuration was adopted, and a coupling, an intermediate, and gears were arranged as illustrated in FIG. 2 so that a driving force was input to an axial end portion of a toner-supplying roller (hereinafter referred to as “RS input configuration”). In addition, the arrangement of the coupling, the intermediate, and the gears, and the setting of the gear ratio of the respective gears, the radius r_{D} of the developing roller, and the radius r_{RS} of the toner-supplying roller were adjusted so as to satisfy R=1.25. The gear ratios of various gears was set so that λ, which was determined by the following formula (E2) from the rotational angular velocity ω_{D} of the developing roller used at this time and the rotational angular velocity ω_{RS} of the toner-supplying roller used at this time, satisfied λ=1.12.

$$λ = {ω}_{RS} / {ω}_{D} \qquad ( E2 )$$

In addition, the radius r_{D} of the developing roller used at this time was r_{D}=12.00 [mm], and the radius r_{RS} of the toner-supplying roller used at this time was r_{RS}=13.35 [mm]. When those values are used, λ×r_{RS}/r_{D}=1.25 is established, and the condition of 1.2≤λ×r_{RS}/r_{D}≤1.5 is satisfied.

The electrophotographic photosensitive member 1, the developing roller 1, and the toner-supplying roller 1 produced in the foregoing were mounted on the process cartridge, and Evaluations (2) and (3) were performed. The results thereof are shown in Table 7.

### Examples 2 to 13 and 15 to 26

Evaluations were performed in the same manner as in Example 1 except that the electrophotographic photosensitive member, the developing roller, the toner-supplying roller, and the value of R were changed as shown in Table 7. The evaluation results are shown in Table 7.

### Example 14

Evaluations were performed in the same manner as in Example 1 except that a coupling, an intermediate, and gears were arranged as illustrated in FIG. 3 so that a driving force from the outside was input to an end portion of a mandrel of a developing roller (hereinafter referred to as “D input configuration”). The evaluation results are shown in Table 7.

### Comparative Examples 1 to 3

Evaluations were performed in the same manner as in Example 1 except that each combination of the electrophotographic photosensitive member, the developing roller, the toner-supplying roller, and the value of R was changed as shown in Table 8. The evaluation results are shown in Table 8. In any of Comparative Examples, the dynamic friction coefficient was changed owing to an increase in temperature, and a streak-like defective image was conspicuous.

TABLE 7

| | | | | | Toner- | Evaluation | | |
|---|---|---|---|---|---|---|---|---|
| Example | | | Photosensitive | Developing | supplying | (1) | Evaluation | Evaluation |
| No. | R | λ | member | roller | roller | B/A | (2) | (3) |
| Example | 1.25 | 1.12 | Photosensitive | Developing | Toner- | 102% | A | A |
| 1 | | | member 1 | roller 1 | supplying | | | |
| | | | | | roller 1 | | | |
| Example | 1.25 | 1.12 | Photosensitive | Developing | Toner- | 103% | A | A |
| 2 | | | member 1 | roller 2 | supplying | | | |
| | | | | | roller 1 | | | |
| Example | 1.25 | 1.12 | Photosensitive | Developing | Toner- | 100% | A | A |
| 3 | | | member 1 | roller 3 | supplying | | | |
| | | | | | roller 1 | | | |
| Example | 1.25 | 1.12 | Photosensitive | Developing | Toner- | 104% | A | B |
| 4 | | | member 1 | roller 4 | supplying | | | |
| | | | | | roller 1 | | | |
| Example | 1.25 | 1.12 | Photosensitive | Developing | Toner- | 108% | B | C |
| 5 | | | member 1 | roller 5 | supplying | | | |
| | | | | | roller 1 | | | |
| Example | 1.25 | 1.12 | Photosensitive | Developing | Toner- | 107% | B | C |
| 6 | | | member 1 | roller 6 | supplying | | | |
| | | | | | roller 1 | | | |
| Example | 1.25 | 1.12 | Photosensitive | Developing | Toner- | 100% | B | B |
| 7 | | | member 2 | roller 2 | supplying | | | |
| | | | | | roller 1 | | | |
| Example | 1.25 | 1.12 | Photosensitive | Developing | Toner- | 99% | A | A |
| 8 | | | member 3 | roller 2 | supplying | | | |
| | | | | | roller 1 | | | |
| Example | 1.25 | 1.12 | Photosensitive | Developing | Toner- | 99% | A | A |
| 9 | | | member 4 | roller 2 | supplying | | | |
| | | | | | roller 1 | | | |
| Example | 1.25 | 1.12 | Photosensitive | Developing | Toner- | 100% | A | A |
| 10 | | | member 5 | roller 2 | supplying | | | |
| | | | | | roller 1 | | | |
| Example | 1.2 | 1.08 | Photosensitive | Developing | Toner- | 102% | A | B |
| 11 | | | member 6 | roller 2 | supplying | | | |
| | | | | | roller 1 | | | |
| Example | 1.4 | 1.26 | Photosensitive | Developing | Toner- | 102% | B | C |
| 12 | | | member 6 | roller 2 | supplying | | | |
| | | | | | roller 1 | | | |
| Example | 1.5 | 1.35 | Photosensitive | Developing | Toner- | 102% | B | C |
| 13 | | | member 6 | roller 2 | supplying | | | |
| | | | | | roller 1 | | | |
| Example | 1.25 | 1.12 | Photosensitive | Developing | Toner- | 99% | C | C |
| 14 | | | member 1 | roller 2 | supplying | | | |
| | | | | | roller 1 | | | |
| Example | 1.25 | 1.12 | Photosensitive | Developing | Toner- | 108% | B | B |
| 15 | | | member 7 | roller 2 | supplying | | | |
| | | | | | roller 1 | | | |
| Example | 1.25 | 1.12 | Photosensitive | Developing | Toner- | 107% | B | B |
| 16 | | | member 8 | roller 2 | supplying | | | |
| | | | | | roller 1 | | | |
| Example | 1.25 | 1.12 | Photosensitive | Developing | Toner- | 103% | B | B |
| 17 | | | member 9 | roller 2 | supplying | | | |
| | | | | | roller 1 | | | |
| Example | 1.25 | 1.12 | Photosensitive | Developing | Toner- | 104% | B | B |
| 18 | | | member 10 | roller 2 | supplying | | | |
| | | | | | roller 1 | | | |
| Example | 1.25 | 1.12 | Photosensitive | Developing | Toner- | 106% | B | C |
| 19 | | | member 11 | roller 2 | supplying | | | |
| | | | | | roller 1 | | | |
| Example | 1.25 | 1.12 | Photosensitive | Developing | Toner- | 105% | B | C |
| 20 | | | member 12 | roller 2 | supplying | | | |
| | | | | | roller 1 | | | |
| Example | 1.25 | 1.12 | Photosensitive | Developing | Toner- | 105% | B | C |
| 21 | | | member 13 | roller 2 | supplying | | | |
| | | | | | roller 1 | | | |
| Example | 1.25 | 1.12 | Photosensitive | Developing | Toner- | 109% | B | C |
| 22 | | | member 14 | roller 2 | supplying | | | |
| | | | | | roller 1 | | | |
| Example | 1.25 | 1.12 | Photosensitive | Developing | Toner- | 102% | A | B |
| 23 | | | member 15 | roller 2 | supplying | | | |
| | | | | | roller 1 | | | |
| Example | 1.25 | 1.12 | Photosensitive | Developing | Toner- | 102% | B | C |
| 24 | | | member 15 | roller 2 | supplying | | | |
| | | | | | roller 2 | | | |
| Example | 1.25 | 1.12 | Photosensitive | Developing | Toner- | 102% | C | C |
| 25 | | | member 15 | roller 2 | supplying | | | |
| | | | | | roller 3 | | | |
| Example | 1.25 | 1.12 | Photosensitive | Developing | Toner- | 102% | A | B |
| 26 | | | member 16 | roller 2 | supplying | | | |
| | | | | | roller 1 | | | |

TABLE 8

| Comparative | | | | | Toner- | Evaluation | | |
|---|---|---|---|---|---|---|---|---|
| Example | | | Photosensitive | Developing | supplying | (1) | Evaluation | Evaluation |
| No. | R | λ | member | roller | roller | B/A | (2) | (3) |
| Comparative | 1.6 | 1.44 | Photosensitive | Developing | Toner- | 100% | D | D |
| Example 1 | | | member 1 | roller 1 | supplying | | | |
| | | | | | roller 1 | | | |
| Comparative | 1.1 | 0.98 | Photosensitive | Developing | Toner- | 100% | D | D |
| Example 2 | | | member 1 | roller 1 | supplying | | | |
| | | | | | roller 1 | | | |
| Comparative | 1.25 | 1.12 | Photosensitive | Developing | Toner- | 115% | C | D |
| Example 3 | | | member 17 | roller 1 | supplying | | | |
| | | | | | roller 1 | | | |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-075148, filed Apr. 28, 2023, and Japanese Patent Application No. 2024−026872, filed Feb. 26, 2024, which are hereby incorporated by reference herein in their entirety.

What is claimed is:

1. A process cartridge being detachably attachable onto a main body of an electrophotographic apparatus,
the process cartridge comprising:
an electrophotographic photosensitive member;
a developing roller configured to develop an electrostatic latent image formed on a surface of the electrophotographic photosensitive member; and
a toner-supplying roller arranged in contact with the developing roller and configured to supply toner to the developing roller,
wherein the developing roller and the toner-supplying roller are configured so that
a movement direction of a surface of the developing roller and a movement direction of a surface of the toner-supplying roller at the time of operation are opposite to each other at a contact position of the developing roller and the toner-supplying roller, and
the developing roller and the toner-supplying roller are rotated while R represented by the following formula (E1) satisfies 1.2≤R≤1.5:
$$R = {V}_{RS} / {V}_{D} \qquad ( E1 )$$
in the formula (E1), VRS represents an absolute value of a peripheral velocity [m/s] of the toner-supplying roller, and V_{D} represents an absolute value of a peripheral velocity [m/s] of the developing roller,
wherein the surface of the developing roller is a surface of an elastic layer,
wherein the toner-supplying roller includes a shaft body and a resin layer formed on an outer peripheral surface of the shaft body, and
wherein the electrophotographic photosensitive member includes a surface layer containing a polyarylate resin including a structural unit represented by the following formula (A1) and a structural unit represented by the following formula (A2).

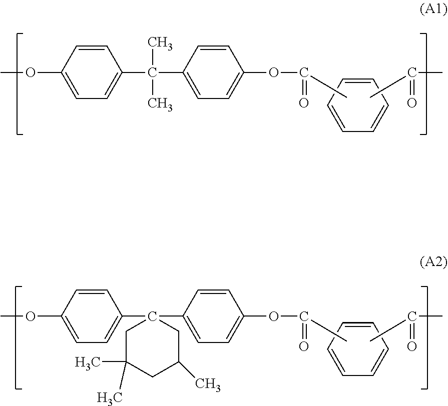

2. The process cartridge according to claim 1, wherein a ¹H-nuclear magnetic resonance spectrum obtained by subjecting a polymer component recovered from the surface layer of the electrophotographic photosensitive member to ¹H-nuclear magnetic resonance analysis in deuterated chloroform has peaks at 8.97±0.02 ppm, 8.43±0.02 ppm, 7.67±0.02 ppm, 8.30±0.02 ppm, 1.71±0.03 ppm, 0.42±0.02 ppm, and 1.01±0.02 ppm.

3. The process cartridge according to claim 1, wherein a molar ratio between the structural unit represented by the formula (A1) and the structural unit represented by the formula (A2) in the surface layer of the electrophotographic photosensitive member falls within a range of from 1.4:0.7 to 1.0:1.1 (structural unit represented by the formula (A1):structural unit represented by the formula (A2)).

4. The process cartridge according to claim 1, wherein a content ratio of the polyarylate resin including the structural unit represented by the formula (A1) and the structural unit represented by the formula (A2) with respect to a total mass of the surface layer in the surface layer of the electrophotographic photosensitive member is 15 mass % or more.

5. The process cartridge according to claim 1 further comprising:
a driving force-receiving portion configured to receive a driving force for driving the toner-supplying roller;
a first driving force-transmitting portion configured to transmit the driving force received by the driving force-receiving portion to the toner-supplying roller; and
a second driving force-transmitting portion configured to transmit a driving force generated by drive of the toner-supplying roller to the developing roller.

6. The process cartridge according to claim 5,
wherein the second driving force-transmitting portion includes a third driving force-transmitting portion, a fourth driving force-transmitting portion, and a fifth driving force-transmitting portion,
wherein the third driving force-transmitting portion is arranged in an end portion of the shaft body of the toner-supplying roller, and is configured to transmit the driving force generated by drive of the toner-supplying roller to the fourth driving force-transmitting portion,
wherein the fourth driving force-transmitting portion is configured to transmit a driving force to the fifth driving force-transmitting portion by being driven with the driving force received from the third driving force-transmitting portion, and
wherein the fifth driving force-transmitting portion is arranged in an end portion of a mandrel of the developing roller, and is configured to receive the driving force from the fourth driving force-transmitting portion to drive the developing roller.

7. The process cartridge according to claim 5, wherein when a radius of the developing roller is represented by r_{D} [mm], and a radius of the toner-supplying roller is represented by r_{RS} [mm], the toner-supplying roller, the second driving force-transmitting portion, and the developing roller are driven to be coupled so that λ represented by the following formula (E2) satisfies 1.2≤λ×r_{RS}/r_{D}≤1.5:
$$λ = {ω}_{RS} / {ω}_{D} \qquad ( E2 )$$
in the formula (E2), ω_{RS} represents a rotational angular velocity [rad/s] of the toner-supplying roller, and ω_{D} represents a rotational angular velocity [rad/s] of the developing roller.

8. The process cartridge according to claim 1, wherein the R satisfies 1.2≤R≤1.3.

9. The process cartridge according to claim 1, wherein the surface of the developing roller has an MD-1 hardness of 20 to 55°.

10. The process cartridge according to claim 1, wherein the resin layer is a foamed layer.

11. The process cartridge according to claim 1, wherein the resin layer contains a polyurethane resin as a binder resin.

12. The process cartridge according to claim 1, wherein the resin layer contains an electronic electroconductive filler.

13. An electrophotographic apparatus comprising a process cartridge,
wherein the process cartridge is detachably attachable onto a main body of the electrophotographic apparatus,
wherein the process cartridge includes:
an electrophotographic photosensitive member;
a developing roller configured to develop an electrostatic latent image formed on a surface of the electrophotographic photosensitive member; and
a toner-supplying roller arranged in contact with the developing roller and configured to supply toner to the developing roller,
wherein the developing roller and the toner-supplying roller are configured so that
a movement direction of a surface of the developing roller and a movement direction of a surface of the toner-supplying roller at the time of operation are opposite to each other at a contact position of the developing roller and the toner-supplying roller, and
the developing roller and the toner-supplying roller are rotated while R represented by the following formula (E1) satisfies 1.2≤R≤1.5:
$$R = {V}_{RS} / {V}_{D} \qquad ( E1 )$$
in the formula (E1), VRS represents an absolute value of a peripheral velocity [m/s] of the toner-supplying roller, and V_{D} represents an absolute value of a peripheral velocity [m/s] of the developing roller,
wherein the surface of the developing roller is a surface of an elastic layer,
wherein the toner-supplying roller includes a shaft body and a resin layer formed on an outer peripheral surface of the shaft body, and
wherein the electrophotographic photosensitive member includes a surface layer containing a polyarylate resin including a structural unit represented by the following formula (A1) and a structural unit represented by the following formula (A2). [chemical structure]
